(19) United States
(12) Patent Application Publication
(10) Pub. No.: US 2025/0340703 A1
(43) Pub. Date: Nov. 6, 2025

(54) METHOD FOR PRODUCING HALOGEN-BASED RESIN COMPOSITION

(71) Applicant: KAO CORPORATION, Tokyo (JP)

(72) Inventors: Satoshi WADA, Wakayama-shi (JP); Osamu TAKIGUCHI, Wakayama-shi (JP)

(73) Assignee: KAO CORPORATION, Tokyo (JP)

(21) Appl. No.: 18/707,779

(22) PCT Filed: Oct. 17, 2022
(86) PCT No.: PCT/JP2022/038607

§ 371 Date: Sep. 30, 2024

(30) Foreign Application Priority Data
Nov. 10, 2021 (JP) 2021-183475

(51) Int. Cl. C08J 3/18; C08K 3/26; C08K 5/134

(52) U.S. Cl. CPC C08J 3/18; C08K 3/26; C08K 5/134; C08J 2327/06; C08J 2433/14; C08K 2003/265

(57) ABSTRACT

The present invention relates to a method for producing a chlorine atom-containing resin composition, including the following steps 1 to 3 in which the step 1 is first carried out: Step 1: mixing an anionic polymer and a plasticizer with each other; Step 2: further mixing a basic inorganic filler with a mixture obtained in the preceding step; and Step 3: further mixing a halogen-based resin with a mixture obtained in the preceding step.

### FIELD OF THE INVENTION

The present invention relates to a method for producing a halogen-based resin composition.

### BACKGROUND OF THE INVENTION

A halogen-based resin, such as a vinyl chloride resin (PVC), etc., is an important resin that has been used as a general-purpose polymer in various application fields. For example, the PVC has been used in the application fields including interior materials for housing, such as wallpapers, etc.; versatile goods, such as toys, etc.; automotive materials, such as sealing materials, etc.; and the like.

When using the halogen-based resin, a plasticizer, a diluent, a viscosity reducer, a filler, such as calcium carbonate, etc., a pigment, a fire retardant, a foaming agent, a stabilizer and the like have been compounded, for example, in a resin powder of the halogen-based resin, to prepare a halogen-based resin composition. However, many of the conventional halogen-based resin compositions often tend to be highly viscous, and therefore tend suffer from such a problem that it is difficult or impossible to subject such halogen-based resin compositions to proper processing steps.

As the method of reducing a viscosity of the halogen-based resin composition, it is conventionally known that a hydrocarbon-based solvent, such as mineral spirit, an alkyl benzene, paraffin, etc., or an anionic surfactant, a polyoxyethylene alkyl phenol ether, polyethylene glycol, a glycerin alkyl ester, etc., are used as a diluent or a viscosity reducer. These diluents or viscosity reducers are added to the halogen-based resin after production thereof or the halogen-based resin composition upon preparation thereof. However, these diluents or viscosity reducers have failed to impart sufficient viscosity reducing effects to the resulting halogen-based resin composition, in particular, the effects of reducing the viscosity of the halogen-based resin composition tend to be insufficient in the case where the fillers, such as calcium carbonate, etc., are compounded in the halogen-based resin composition.

JP 2001-335696A (Patent Literature 1) discloses, as to a method of reducing a viscosity of a halogen-based resin composition, a resin composition that contains at least one additive selected from the group consisting of an ester of a fatty acid and an aliphatic alcohol and a (poly)alkylene glycol mono- or di-alkyl ether, at least one additive selected from the group consisting of a polyoxyalkylene alkyl ether and a polyoxyalkylene alkyl ether carboxylate, a plasticizer and a filler in respective specific amounts based on a vinyl chloride-based resin.

In addition, JP H7-504846A (Patent Literature 2) discloses a method for producing a resin composition, which includes the steps of adsorbing a surfactant that is characterized by a plurality of addition-copolymer chains, characterized, on each chain, by an average of at least 0.5 adsorptive or chemisorptive group and at least one polyether residue, and characterized, between the chains, by at least one divalent polyether residue, onto an inorganic solid in water, then filtering and drying the resulting dispersion to prepare a dispersible inorganic solid, and further redispersing the resulting dispersible inorganic solid in a mixture of a plasticizer and a vinyl chloride resin.

### SUMMARY OF THE INVENTION

The present invention relates to a method for producing a halogen-based resin composition, including the following steps 1 to 3 in which the step 1 is first carried out:
Step 1: mixing an anionic polymer and a plasticizer with each other;
Step 2: further mixing a basic inorganic filler with a mixture obtained in the preceding step; and
Step 3: further mixing a halogen-based resin with a mixture obtained in the preceding step.

### DETAILED DESCRIPTION OF THE INVENTION

In the resin composition described in the aforementioned Patent Literature 1, since the additives are caused to undergo adsorption onto and desorption from the filler, it is required that a large amount of the additives are used therein in order to reduce a viscosity of the resin composition. As a result, the resin composition tends to pose such a problem that a resin molded article obtained by molding the resin composition suffers from bleed-out of the additives.

In addition, in the production method described in the Patent Literature 2, it is required to conduct such a complicated step that the anionic polymer is neutralized with an alkali to dissolve the anionic polymer in water, and after the neutralized anionic polymer is allowed to come into contact with the inorganic solid, the resulting mixture is subjected to filtration and drying to remove water therefrom and thereby obtain the inorganic solid onto which the anionic polymer is adsorbed, and further the resulting solid is mixed with the vinyl chloride resin and the plasticizer.

The present invention relates to a method for producing a halogen-based resin composition that is improved in processability by reducing a slurry viscosity upon production of the halogen-based resin composition.

The present inventors have found that the aforementioned conventional problems can be solved by such a simple method as conducted in the absence of water in which an anionic polymer and a plasticizer are mixed with each other, and the resulting mixture is further mixed with a basic inorganic filler and a halogen-based resin.

That is, the present invention relates to a method for producing a halogen-based resin composition, including the following steps 1 to 3 in which the step 1 is first carried out:
Step 1: mixing an anionic polymer and a plasticizer with each other;
Step 2: further mixing a basic inorganic filler with a mixture obtained in the preceding step; and
Step 3: further mixing a halogen-based resin with a mixture obtained in the preceding step.

In accordance with the present invention, there is provided a method for producing a halogen-based resin composition that is improved in processability by reducing a slurry viscosity upon production of the halogen-based resin composition.

### [Method for Producing Halogen-Based Resin Composition]

The method for producing a halogen-based resin composition according to the present invention (hereinafter also referred to merely as a “production method of the present invention”) includes the step of mixing an anionic polymer and a plasticizer with each other (Step 1), the step of further mixing a basic inorganic filler with a mixture obtained in the preceding step (Step 2), and the step of further mixing a halogen-based resin with a mixture obtained in the preceding step (Step 3), in which the step 1 is first carried out.

Upon conducting the step 2 and the step 3, the steps 2 and 3 may be carried out at the same time. In addition, the step 2 may be carried out prior to the step 3, whereas, on the contrary, the step 3 may be carried out prior to the step 2. From the viewpoint of improving production efficiency of the resin composition, it is preferred that the step 2 be carried out prior to the step 3.

From the viewpoint of improving production efficiency of the resin composition, the content of water in the step 1 is preferably not more than 1% by mass, more preferably not more than 0.1% by mass, even more preferably not more than 0.01% by mass and further even more preferably substantially 0% by mass, on the basis of the anionic polymer.

From the viewpoint of improving production efficiency of the resin composition, the content of water in the step 2 is preferably not more than 1% by mass, more preferably not more than 0.1% by mass, even more preferably not more than 0.01% by mass and further even more preferably substantially 0% by mass, on the basis of the basic inorganic filler.

From the viewpoint of improving production efficiency of the resin composition, the steps 1, the step 2 and the step 3 preferably include no procedure for removing water.

From the viewpoint of improving production efficiency of the resin composition, in the step 1, the anionic polymer that is in the form of a solution prepared by dissolving the anionic polymer in an organic solvent may be mixed with the plasticizer. In the case where the organic solvent is contained in the resulting mixture, the organic solvent is preferably removed from the mixture either subsequent to the step 1, subsequent to the step 2 or subsequent to the step 3.

In accordance with the present invention, it is possible to provide a method for producing a halogen-based resin composition that is improved in processability by reducing a slurry viscosity upon production of the halogen-based resin composition. The reason why the aforementioned advantageous effect can be attained by the present invention is considered as follow though it is not necessarily clearly determined yet.

In the halogen-based resin composition containing the plasticizer, the basic inorganic filler exhibits hydrophilic properties and is therefore flocculated in the plasticizer to form a network structure, so that the basic inorganic filler is stabilized. However, the basic inorganic filler that is flocculated to form a network structure tends to act to increase a viscosity of the halogen-based resin composition.

For this reason, it is considered that by adsorbing the anionic polymer onto the surface of the basic inorganic filler to render the surface of the basic inorganic filler hydrophobic, the basic inorganic filler can be prevented from being flocculated to form a network structure in the resin composition, so that it is possible to reduce a slurry viscosity of the halogen-based resin composition. However, unlike a low-molecular surfactant, the high-molecular anionic polymer tends to be adsorbed at multiple points on the surface of the basic inorganic filler and therefore hardly desorbed from the surface of the basic inorganic filler. In the case where the anionic polymer is unevenly locally adsorbed onto the surface of the basic inorganic filler, it tends to be difficult to allow the anionic polymer to be homogeneously present in the resin composition. Furthermore, if the high-molecular anionic polymer is unevenly locally adsorbed onto the surface of the basic inorganic filler, the basic inorganic filler tends to be still flocculated to form a network structure, so that the halogen-based resin composition tends to suffer from increase in viscosity thereof.

In the method for producing a halogen-based resin composition according to the present invention, it is considered that by mixing the anionic polymer and the plasticizer with each other in the step 1, the anionic polymer is homogeneously dissolved and dispersed in the plasticizer, and by mixing the basic inorganic filler with the anionic polymer and the plasticizer in the step 2, the anionic polymer can act uniformly on the surface of the basic inorganic filler. For this reason, the anionic polymer is evenly adsorbed onto the surface of the basic inorganic filler to thereby render the surface of the basic inorganic filler uniformly hydrophobic, so that the basic inorganic filler is more strongly inhibited from suffering from flocculation thereof and forming a network structure, whereby it is possible to reduce a viscosity of the slurry obtained in the step 2. It is also considered that when further mixing the halogen-based resin in the step 3, the basic inorganic filler is more strongly inhibited from suffering from flocculation thereof and forming a network structure in the resin composition, so that it is possible to reduce a slurry viscosity of the halogen-based resin composition and thereby improve processability of the halogen-based resin composition.

In the case where the additives are incorporated in the halogen-based resin composition, the additives may be mixed therein together with the halogen-based resin either in the step 3 or subsequent to the step 3. By previously homogeneously mixing the anionic polymer in the plasticizer, it is possible to more evenly adsorb the anionic polymer onto the basic inorganic filler.

When sequentially mixing the respective components, the mixing in the step 1 may be carried out using a magnetic stirrer, a Labomixer, etc., and the mixing in each of the step 2 and the step 3 may be carried out using a stirring device or a kneading machine. Examples of the stirring device include a Labomixer, a mortar mixer, a Henschel mixer, a Banbury mixer, a ribbon blender, and the like. Examples of the kneading machine include a conical twin screw extruder, a parallel twin screw extruder, a single screw extruder, a co-kneader-type kneader, a roll kneader, and the like.

The mixing operation condition in the step 1 is preferably not less than 150 rpm, more preferably not less than 200 rpm and even more preferably not less than 250 rpm from the viewpoint of sufficiently mixing the anionic polymer and the plasticizer with each other, and is also preferably not more than 4,500 rpm, more preferably not more than 4,000 rpm and even more preferably not more than 3,500 rpm from the viewpoint of inhibiting increase in temperature. More specifically, the mixing operation condition in the step 1 is preferably not less than 150 rpm and not more than 4,500 rpm, more preferably not less than 200 rpm and not more than 4,000 rpm, and even more preferably not less than 250 rpm and not more than 3,500 rpm. The mixing time in the step 1 is preferably not shorter than 1 minute and 30 seconds, more preferably not shorter than 2 minutes and even more preferably not shorter than 2 minutes and 30 seconds from the viewpoint of sufficiently mixing the anionic polymer and the plasticizer with each other, and is also preferably not longer than 5 minutes, more preferably not longer than 4 minutes and even more preferably not longer than 3 minutes and 30 seconds from the viewpoint of improving production efficiency of the resin composition. More specifically, the mixing time in the step 1 is preferably not shorter than 1 minute and 30 seconds and not longer than 5 minutes, more preferably not shorter than 2 minutes and not longer than 4 minutes, and even more preferably not shorter than 2 minutes and 30 seconds and not longer than 3 minutes and 30 seconds.

In addition, in the step 1, the anionic polymer that is in the form of a solution prepared by dissolving the anionic polymer in an organic solvent may be mixed with the plasticizer. In this case, the mixing operation condition in the step 1 is preferably not less than 100 rpm, more preferably not less than 150 rpm and even more preferably not less than 180 rpm from the viewpoint of sufficiently mixing the anionic polymer and the plasticizer with each other, and is also preferably not more than 4,500 rpm, more preferably not more than 4,000 rpm and even more preferably not more than 3,500 rpm from the viewpoint of inhibiting increase in temperature. More specifically, the mixing operation condition for mixing the plasticizer in the form of a solution prepared by dissolving the plasticizer in an organic solvent, with the anionic polymer in the step 1 is preferably not less than 100 rpm and not more than 4,500 rpm, more preferably not less than 150 rpm and not more than 4,000 rpm, and even more preferably not less than 180 rpm and not more than 3,500 rpm. The organic solvent is preferably removed simultaneously with the mixing or subsequent to the mixing. From the viewpoint of improving production efficiency of the resin composition, the organic solvent is preferably removed simultaneously with the mixing. In the case where the organic solvent is removed simultaneously with the mixing, the mixing time is preferably not shorter than 10 minutes, more preferably not shorter than 30 minutes and even more preferably not shorter than 45 minutes, and is also preferably not longer than 3 hours, more preferably not longer than 2 hours and even more preferably not longer than 1 hour and 30 minutes. More specifically, the mixing time for mixing the plasticizer in the form of a solution prepared by dissolving the plasticizer in an organic solvent, with the anionic polymer in the step 1 is preferably not shorter than 10 minutes and not longer than 3 hours, more preferably not shorter than 30 minutes and not longer than 2 hours, and even more preferably not shorter than 45 minutes and not longer than 1 hour and 30 minutes. The removal of the organic solvent is preferably conducted by heating. The heating temperature is preferably not lower than 120° C., more preferably not lower than 140° C. and even more preferably not lower than 150° C., and is also preferably not higher than 200° C., more preferably not higher than 180° C. and even more preferably not higher than 170° C. More specifically, the heating temperature is preferably not lower than 120° C. and not higher than 200° C., more preferably not lower than 140° C. and not higher than 180° C., and even more preferably not lower than 150° C. and not higher than 170° C.

The mixing operation condition in the step 2 is preferably not less than 2,000 rpm, more preferably not less than 2,500 rpm and even more preferably not less than 3,000 rpm from the viewpoint of sufficiently acting the anionic polymer on the basic inorganic filler, and is also preferably not more than 8,000 rpm, more preferably not more than 7,500 rpm and even more preferably not more than 7,000 rpm from the viewpoint of inhibiting increase in temperature. More specifically, the mixing operation condition in the step 2 is preferably not less than 2,000 rpm and not more than 8,000 rpm, more preferably not less than 2,500 rpm and not more than 7,500 rpm, and even more preferably not less than 3,000 rpm and not more than 7,000 rpm. The mixing time in the step 2 is preferably not shorter than 1 minute and 30 seconds, more preferably not shorter than 2 minutes and even more preferably not shorter than 2 minutes and 30 seconds from the viewpoint of sufficiently acting the anionic polymer on the basic inorganic filler, and is also preferably not longer than 5 minutes, more preferably not longer than 4 minutes and even more preferably not longer than 3 minutes and 30 seconds from the viewpoint of improving production efficiency of the resin composition. More specifically, the mixing time in the step 2 is preferably not shorter than 1 minute and 30 seconds and not longer than 5 minutes, more preferably not shorter than 2 minutes and not longer than 4 minutes, and even more preferably not shorter than 2 minutes and 30 seconds and not longer than 3 minutes and 30 seconds.

In the case where the step 2 is carried out subsequent to the step 1, the slurry viscosity of the mixture of the anionic polymer, the plasticizer and the basic inorganic filler as measure at 25° C. after termination of the step 2 is preferably not more than 60 Pa·s, more preferably not more than 30 Pa·s and even more preferably not more than 10 Pas from the viewpoint of reducing a slurry viscosity of the halogen-based resin composition produced according to the production process of the present invention to thereby improve production efficiency of the resin composition.

The slurry viscosity may be measured by the method described in Examples below.

The mixing operation condition in the step 3 is not particularly limited as long as it may be used in ordinary methods for producing halogen-based resin compositions. By conducting the mixing in the step 3 using a stirring device, the halogen-based resin composition may be obtained in the form of a mixed powder. In addition, by conducting the mixing in the step 3 using a kneading machine to subject the resin mixture to melt-molding, it is possible to obtain the halogen-based resin composition in the form of a mixed powder, pellets or a paste.

In the case where the step 1, the step 2 and the step 3 are sequentially carried out in this order, the slurry viscosity of the mixture of the anionic polymer, the plasticizer, the basic inorganic filler and the halogen-based resin as measure at 25° C. after termination of the step 3 is preferably not more than 23 Pa·s, more preferably not more than 20 Pas and even more preferably not more than 17 Pa's from the viewpoint of improving processability of the halogen-based resin composition produced according to the production process of the present invention.

### [Anionic Polymer]

The anionic polymer as described in the present invention is a polymer containing one or more anionic groups in a molecule thereof. As the anionic groups, from the viewpoint of facilitating adsorption of the anionic polymer to the basic inorganic filler, there may be mentioned a carboxy group, a sulfonic acid group, a sulfinic acid group, a sulfuric acid group, a sulfurous acid group, a phosphoric acid group, a phosphorous acid group, and the like. Among the anionic polymers containing these anionic groups, preferred are those anionic polymers containing a carboxy group or a sulfonic acid group, and more preferred are those anionic polymers containing a carboxy group.

The anionic polymer is preferably in the form of a polymer that contains an anionic group-containing constitutional unit and a hydrophobic group-containing constitutional unit.

As the anionic group-containing constitutional unit, from the viewpoint of facilitating dissolution or dispersion of the anionic polymer in the plasticizer, there may be mentioned constitutional units derived from α,β-unsaturated carboxylic acids, such as (meth)acrylic acid, fumaric acid, maleic acid, crotonic acid, itaconic acid, etc., constitutional units derived from styrene-based compounds which are substituted with the aforementioned anionic groups, and the like. Among these constitutional units, preferred are the constitutional units derived from α,β-unsaturated carboxylic acids, more preferred are the constitutional units derived from (meth)acrylic acid, and even more preferred is the constitutional unit derived from methacrylic acid.

Incidentally, the term “(meth)acrylic acid” as used in the present specification means at least one compound selected from the group consisting of acrylic acid and methacrylic acid, and the term “(meth)acrylate” as used in the present specification means at least one compound selected from the group consisting of an acrylate and a methacrylate.

As the hydrophobic group-containing constitutional unit, from the viewpoint of facilitating dissolution or dispersion of the anionic polymer in the plasticizer, there may be mentioned constitutional units derived from α,β-unsaturated carboxylic acid esters, α,β-unsaturated carboxylic acid amides, styrene-based compounds, C₃ to C₁₀ linear or branched alkenes, and the like. Among these compounds from which the hydrophobic group-containing constitutional units are derived, preferred are α,β-unsaturated carboxylic acid esters, α,β-unsaturated carboxylic acid amides and linear or branched alkenes, and more preferred are α,β-unsaturated carboxylic acid esters.

Meanwhile, in the case where the α,β-unsaturated carboxylic acid esters and the α,β-unsaturated carboxylic acid amides are in the form of an ester of a polycarboxylic acid and an amide of a polycarboxylic acid, respectively, and contain at least one carboxy group, the ester and amide of the polycarboxylic acid constitute both of the anionic group-containing constitutional unit and the hydrophobic group-containing constitutional unit.

As the α,β-unsaturated carboxylic acid esters, from the viewpoint of ensuring good availability, there may be mentioned, for example, esters of an α,β-unsaturated carboxylic acid and a linear or branched alkyl alcohol. The number of carbon atoms contained in the linear or branched alkyl alcohol is preferably not less than 1, more preferably not less than 3 and even more preferably not less than 5, and is also preferably not more than 30, more preferably not more than 25 and even more preferably not more than 20, from the viewpoint of improving compatibility of the anionic polymer with the plasticizer. More specifically, the number of carbon atoms contained in the linear or branched alkyl alcohol is preferably not less than 1 and not more than 30, more preferably not less than 3 and not more than 25, and even more preferably not less than 5 and not more than 20.

As the aforementioned esters of the α,β-unsaturated carboxylic acid and the linear or branched alkyl alcohol, from the viewpoint of improving production efficiency of the halogen-based resin composition owing to increased solubility of the anionic polymer in the plasticizer, and improving processability of the halogen-based resin composition owing to reduction of a slurry viscosity of the halogen-based resin composition, preferred are 2-ethylhexyl (meth)acrylate, lauryl (meth)acrylate and stearyl (meth)acrylate.

In addition, the α,β-unsaturated carboxylic acid esters may be in the form of an ester of a polyalkylene glycol having not less than 1 and not more than 40 repeating units which contains a medium-chain or long-chain alkyl group at a one terminal end thereof, and an α,β-unsaturated carboxylic acid, from the viewpoint of further enhancing solubility of the anionic polymer in the plasticizer. The number of carbon atoms contained in the medium-chain or long-chain alkyl group is preferably not less than 4, more preferably not less than 6 and even more preferably not less than 8, and is also preferably not more than 24, more preferably not more than 18 and even more preferably not more than 16, from the viewpoint of improving compatibility of the anionic polymer with the plasticizer. More specifically, the number of carbon atoms contained in the medium-chain or long-chain alkyl group is preferably not less than 4 and not more than 24, more preferably not less than 6 and not more than 18, and even more preferably not less than 8 and not more than 16.

As the aforementioned ester of the polyalkylene glycol and the α,β-unsaturated carboxylic acid, from the viewpoint of improving production efficiency of the halogen-based resin composition owing to increased solubility of the anionic polymer in the plasticizer, and improving processability of the halogen-based resin composition owing to reduction of a slurry viscosity of the halogen-based resin composition, preferred are stearoxypolyethylene glycol mono(meth)acrylate, lauroxypolyethylene glycol mono(meth)acrylate and 2-ethylhexyloxypropylene glycol polyethylene glycol mono(meth)acrylate.

As the α,β-unsaturated carboxylic acid amides, from the viewpoint of facilitating introduction thereof into a molecular structure of the anionic polymer, there may be mentioned, for example, amides of an α,β-unsaturated carboxylic acid and a linear or branched primary alkyl amine. The number of carbon atoms contained in the linear or branched primary alkyl amine is preferably not less than 4, more preferably not less than 6 and even more preferably not less than 8, and is also preferably not more than 30, more preferably not more than 25 and even more preferably not more than 20, from the viewpoint of improving compatibility of the anionic polymer with the plasticizer. More specifically, the number of carbon atoms contained in the linear or branched primary alkyl amine is preferably not less than 4 and not more than 30, more preferably not less than 6 and not more than 25, and even more preferably not less than 8 and not more than 20.

As the styrene compounds, from the viewpoint of ensuring good availability, there may be mentioned, for example, styrene, α-methyl styrene and the like.

As the C₃ to C₁₀ linear or branched alkenes, from the viewpoint of facilitating copolymerization thereof with maleic anhydride, there may be mentioned, for example, isoprene, butadiene, isobutylene, diisobutylene and the like.

Among the aforementioned hydrophobic group-containing constitutional units, from the viewpoint of further improving production efficiency of the halogen-based resin composition owing to increased solubility of the anionic polymer in the plasticizer, and further improving processability of the halogen-based resin composition owing to reduction of a slurry viscosity of the halogen-based resin composition, preferred are constitutional units derived from at least one compound selected from the group consisting of stearyl (meth)acrylate, 2-ethylhexyl (meth)acrylate, lauryl (meth)acrylate, stearoxypolyethylene glycol mono(meth)acrylate, lauroxypolyethylene glycol (meth)acrylate, 2-ethylhexyloxy polypropylene glycol polyethylene glycol (meth)acrylate and diisobutylene.

The anionic polymer may contain a hydrophilic group-containing constitutional unit from the viewpoint of well controlling a hydrophile-lipophile balance of the resin composition. However, in the present invention, the hydrophilic group-containing constitutional unit does not include the anionic group-containing constitutional unit. Examples of the hydrophilic group-containing constitutional unit include a constitutional unit derived from (meth)acrylamide, dimethyl (meth)acrylamide or acrylonitrile, a constitutional unit derived from an α,β-unsaturated carboxylic acid alkyloxypolyalkylene glycol ester, and the like.

The anionic polymer preferably contains the constitutional unit derived from the α,β-unsaturated carboxylic acid alkyloxypolyalkylene glycol ester, more preferably a constitutional unit derived from an α,β-unsaturated carboxylic acid alkyloxy-polyethylene glycol and/or -polypropylene glycol ester, and even more preferably a constitutional unit derived from an α,β-unsaturated carboxylic acid alkyloxypolyethylene glycol ester, from the viewpoint of facilitating designing of the hydrophile-lipophile balance of the resin composition.

The number of repeating units of an alkylene glycol moiety in the constitutional unit derived from the α,β-unsaturated carboxylic acid alkyloxypolyalkylene glycol ester is preferably not less than 2, more preferably not less than 4 and even more preferably not less than 9, and is also preferably not more than 60, more preferably not more than 55 and even more preferably not more than 45, from the viewpoint of adsorbing the anionic polymer onto the basic inorganic filler and reducing a slurry viscosity of the halogen-based resin composition. More specifically, the number of repeating units of an alkylene glycol moiety in the constitutional unit derived from the α,β-unsaturated carboxylic acid alkyloxypolyalkylene glycol ester is preferably not less than 2 and not more than 60, more preferably not less than 4 and not more than 55, and even more preferably not less than 9 and not more than 45.

The aforementioned constitutional unit derived from the α,β-unsaturated carboxylic acid alkyloxypolyalkylene glycol ester is preferably a constitutional unit derived from methoxypolyethylene glycol mono(meth)acrylate from the viewpoint of adsorbing the anionic polymer onto the basic inorganic filler and improving processability of the halogen-based resin composition owing to reduction of a slurry viscosity of the halogen-based resin composition.

The content of the constitutional unit derived from the α,β-unsaturated carboxylic acid in the anionic polymer, provided that the content of the whole constitutional units therein is 100% by mass, is preferably not less than 1% by mass, more preferably not less than 2% by mass, even more preferably not less than 3% by mass and further even more preferably not less than 5% by mass from the viewpoint of adsorbing the anionic polymer onto the basic inorganic filler and reducing a slurry viscosity of the halogen-based resin composition, and is also preferably not more than 50% by mass, more preferably not more than 40% by mass, even more preferably not more than 30% by mass and further even more preferably not more than 20% by mass from the viewpoint of improving compatibility of the anionic polymer with the plasticizer. More specifically, the content of the constitutional unit derived from the α,β-unsaturated carboxylic acid in the anionic polymer, provided that the content of the whole constitutional units therein is 100% by mass, is preferably not less than 1% by mass and not more than 50% by mass, more preferably not less than 2% by mass and not more than 40% by mass, even more preferably not less than 3% by mass and not more than 30% by mass, and further even more preferably not less than 5% by mass and not more than 20% by mass.

The content of the hydrophobic group-containing constitutional unit in the anionic polymer, provided that the content of the whole constitutional units therein is 100% by mass, is preferably not less than 5% by mass, more preferably not less than 10% by mass and even more preferably not less than 13% by mass from the viewpoint of improving compatibility of the anionic polymer with the plasticizer, and is also preferably not more than 98% by mass, more preferably not more than 95% by mass and even more preferably not more than 93% by mass from the viewpoint of exerting no adverse influence on adsorption of the anionic polymer onto the basic inorganic filler. More specifically, the content of the hydrophobic group-containing constitutional unit in the anionic polymer, provided that the content of the whole constitutional units therein is 100% by mass, is preferably not less than 5% by mass and not more than 98% by mass, more preferably not less than 10% by mass and not more than 95% by mass, and even more preferably not less than 13% by mass and not more than 93% by mass.

The weight-average molecular weight of the anionic polymer is preferably not less than 4,000, more preferably not less than 4,500 and even more preferably not less than 5,000 from the viewpoint of preventing the anionic polymer from being desorbed from the basic inorganic filler, and is also preferably not more than 200,000, more preferably not more than 180,000, even more preferably not more than 170,000, further even more preferably not more than 150,000, still further even more preferably not more than 120,000, still further even more preferably not more than 100,000, still further even more preferably not more than 70,000, still further even more preferably not more than 50,000, still further even more preferably not more than 30,000, and yet still further even more preferably not more than 20,000 from the viewpoint of efficiently adsorbing the anionic polymer onto the basic inorganic filler. More specifically, the weight-average molecular weight of the anionic polymer is preferably not less than 4,000 and not more than 200,000, more preferably not less than 4,000 and not more than 180,000, even more preferably not less than 4,000 and not more than 170,000, further even more preferably not less than 4,500 and not more than 150,000, still further even more preferably not less than 4,500 and not more than 120,000, still further even more preferably not less than 4,500 and not more than 100,000, still further even more preferably not less than 5,000 and not more than 70,000, still further even more preferably not less than 5,000 and not more than 50,000, still further even more preferably not less than 5,000 and not more than 30,000, and yet still further even more preferably not less than 5,000 and not more than 20,000.

The weight-average molecular weight may be measured by the method described in Examples below.

The acid value of the anionic polymer is preferably not less than 30 mgKOH/g, more preferably not less than 40 mgKOH/g and even more preferably not less than 45 mgKOH/g from the viewpoint of adsorbing the anionic polymer onto the basic inorganic filler and reducing a slurry viscosity of the halogen-based resin composition, and is also preferably not more than 150 mgKOH/g, more preferably not more than 130 mgKOH/g, even more preferably not more than 120 mgKOH/g and further even more preferably not more than 100 mgKOH/g from the viewpoint of improving compatibility of the anionic polymer with the plasticizer. More specifically, the acid value of the anionic polymer is preferably not less than 30 mgKOH/g and not more than 150 mgKOH/g, more preferably not less than 40 mgKOH/g and not more than 130 mgKOH/g, even more preferably not less than 45 mgKOH/g and not more than 120 mgKOH/g, and further even more preferably not less than mgKOH/g and not more than 100 mgKOH/g.

The acid value of the anionic polymer may be calculated from a mass ratio between the monomers constituting the anionic polymer. In addition, the acid value of the anionic polymer may also be determined by the method in which the anionic polymer is dissolved in or swelled with an adequate solvent (e.g., methyl ethyl ketone), and then the resulting solution or swelled product is subjected to titration.

The anionic polymer may be neutralized from the viewpoint of enhancing a degree of freedom of molecular design thereof. By carrying out the steps 1 to 3 in the sequential order to produce the halogen-based resin composition, it is possible to attain the advantageous effects of the present invention even when the anionic polymer is neutralized to any degree of neutralization. On the other hand, the slurry viscosity of the halogen-based resin composition that is produced by collectively mixing the neutralized anionic polymer, the plasticizer, the basic inorganic filler and the halogen-based resin together at the same time tends to become larger than the slurry viscosity of the halogen-based resin composition that is produced according to the production method of the present invention. The reason therefor is considered to be that when carrying out the steps 1 to 3 in the sequential order, the anionic polymer is mixed with the basic inorganic filler prior to mixing the basic inorganic filler with the halogen-based resin, so that the surface of the basic inorganic filler tends to be more easily rendered hydrophobic by the anionic polymer adsorbed thereonto as compared to the case where these components are collectively added at the same time.

The degree of neutralization as described herein means the value obtained by dividing a molar amount of a neutralizing agent used therein by a molar amount of the anionic group in the polymer.

Although the anionic polymer may be neutralized as described above, from the viewpoint of improving production efficiency of the halogen-based resin composition owing to enhanced solubility of the anionic polymer in the plasticizer, and improving processability of the halogen-based resin composition owing to reduction of a slurry viscosity of the halogen-based resin composition, the degree of neutralization of the anionic polymer is preferably 0 mol %, i.e., the anionic polymer is preferably in an unneutralized state.

As the neutralizing agent for the anionic polymer, from the viewpoint of ensuring good availability, there may be mentioned, for example, an alkali metal hydroxide, ammonia, an organic amine and the like. Examples of the alkali metal hydroxide include lithium hydroxide, sodium hydroxide, potassium hydroxide and cesium hydroxide. Examples of the organic amine include trimethylamine, ethylamine, diethylamine, triethylamine, triethanolamine and the like.

The mass ratio of the anionic polymer to the basic inorganic filler (anionic polymer/basic inorganic filler) in the production method of the present invention is preferably not less than 0.0001, more preferably not less than 0.0005, even more preferably not less than 0.001 and further even more preferably not less than 0.002, and is also preferably not more than 10, more preferably not more than 5, even more preferably not more than 1, further even more preferably not more than 0.5, still further even more preferably not more than 0.1, still further even more preferably not more than 0.05, still further even more preferably not more than 0.03 and yet still further even more preferably not more than 0.01, from the viewpoint of adsorbing the anionic polymer onto the basic inorganic filler, reducing a slurry viscosity of the halogen-based resin composition and enhancing processability of the halogen-based resin composition. More specifically, the mass ratio of the anionic polymer to the basic inorganic filler is preferably not less than 0.0001 and not more than 10, more preferably not less than 0.0001 and not more than 5, even more preferably not less than 0.0005 and not more than 1, further even more preferably not less than 0.0005 and not more than 0.5, still further even more preferably not less than 0.001 and not more than 0.1, still further even more preferably not less than 0.001 and not more than 0.05, still further even more preferably not less than 0.002 and not more than 0.03, and yet still further even more preferably not less than 0.002 and not more than 0.01.

The amount of the anionic polymer compounded in the halogen-based resin composition in the production method of the present invention is preferably not less than 0.001% by mass and not more than 1.0% by mass on the basis of the halogen-based resin composition from the viewpoint of improving processability of the halogen-based resin composition owing to reduction of a slurry viscosity of the halogen-based resin composition.

### (Method for Producing Anionic Polymer)

The anionic polymer may be produced by copolymerizing monomers, such as an anionic group-containing compound, a hydrophobic group-containing compound, a hydrophilic group-containing compound, etc., by conventionally known polymerization methods. As the polymerization methods, from the viewpoint of enabling production of the anionic polymer using general-purpose facilities, preferred is a solution polymerization method.

The solvent used in the solution polymerization method is not particularly limited as long as the monomers can be dissolved therein. Examples of the preferred solvent include polar solvents, e.g., aromatic solvents, such as toluene, xylene, etc., aliphatic alcohols, ketones, ethers, esters and the like. Among these solvents, more preferred are toluene, methanol, ethanol, acetone, methyl ethyl ketone and the like, and even more preferred are toluene and ethanol. These solvents may be used alone or in the form of a mixture of any two or more thereof.

The polymerization may be carried out in the presence of a polymerization initiator or a polymerization chain transfer agent.

As the polymerization initiator, from the viewpoint of stably conducting the polymerization below a boiling point of the aforementioned solvent, there may be used conventionally known radical polymerization initiators, e.g., azo compounds, such as 2,2′-azobisisobutyronitrile, 2,2′-azobis(2,4-dimethylvaleronitrile), etc., organic peroxides, such as t-butyl peroxyoctoate, benzoyl peroxide, etc., and the like. The amount of the radical polymerization initiator used in the polymerization is preferably not less than 0.1 part by mass and more preferably not less than 0.5 part by mass, and is also preferably not more than 5 parts by mass and more preferably not more than 4 parts by mass, on the basis of 100 parts by mass of the mixture of the monomers. More specifically, the amount of the radical polymerization initiator used in the polymerization is preferably not less than 0.1 part by mass and not more than 5 parts by mass, and more preferably not less than 0.5 part by mass and not more than 4 parts by mass, on the basis of 100 parts by mass of the mixture of the monomers.

As the polymerization chain transfer agent, from the viewpoint of facilitating control of a molecular weight of the anionic polymer, there may be used conventionally known polymerization chain transfer agents, e.g., mercaptans, such as octyl mercaptan, 2-mercaptoethanol, 3-mercapto-1,2-propanediol, mercaptopropionic acid, etc., thiuram disulfides, and the like.

In addition, the type of a polymerization chain of the monomers polymerized is not particularly limited, and may be any of a random type, a block type, a grafted type, etc.

The monomers may include a compound that contains two or more radical-polymerizable carbon-carbon double bonds (crosslinking agent). In the case where the monomers include the crosslinking agent, the content of the crosslinking agent in the whole monomers is preferably not more than 3 mol % from the viewpoint of preventing gelation of the reaction system. The content of the crosslinking agent in the mixture of the monomers is preferably not more than 2 mol %, more preferably not more than 1 mol % and even more preferably not more than 0.5 mol %.

The preferred polymerization conditions may vary depending upon the kinds of polymerization initiators, monomers and solvents used in the polymerization, etc., from the viewpoint of enabling the polymerization using general-purpose facilities. In general, the polymerization temperature is preferably not lower than 30° C. and more preferably not lower than 50° C., and is also preferably not higher than 95° C. and more preferably not higher than 80° C. More specifically, the polymerization temperature is preferably not lower than 30° C. and not higher than 95° C., and more preferably not lower than 50° C. and not higher than 80° C. The polymerization time is preferably not shorter than 1 hour and more preferably not shorter than 2 hours, and is also preferably not longer than 20 hours and more preferably not longer than 10 hours. More specifically, the polymerization time is preferably not shorter than 1 hour and not longer than 20 hours, and more preferably not shorter than 2 hours and not longer than 10 hours. Furthermore, the polymerization is preferably conducted in a nitrogen gas atmosphere or an atmosphere of an inert gas such as argon, etc.

### [Halogen-Based Resin]

The halogen-based resin used in the present invention means a homopolymer or a copolymer of a halogen-containing monomer, or a polymer that is modified with a halogen. Specific examples of the halogen-based resin include at least one resin selected from the group consisting of a vinyl chloride resin, a vinylidene chloride resin, chlorinated polyethylene, chlorinated polypropylene, chloro-sulfonated polyethylene, a chloroprene rubber, and the like, from the viewpoint of ensuring good availability thereof. The halogen-based resin composition of the present invention preferably contains at least one resin selected from the group consisting of a vinyl chloride resin, a vinylidene chloride resin and a chloroprene rubber.

### (Vinyl Chloride Resin)

Examples of the vinyl chloride resin include a vinyl chloride homopolymer as well as a copolymer of vinyl chloride with a monomer copolymerizable with the vinyl chloride (hereinafter also referred to as a “vinyl chloride copolymer”), a graft copolymer obtained by graft-copolymerizing vinyl chloride to a polymer other than the aforementioned vinyl chloride copolymer, and the like.

The aforementioned monomer copolymerizable with vinyl chloride may include those monomers having a reactive double bond in a molecule thereof from the viewpoint of facilitating copolymerization of the monomer with vinyl chloride. Examples of the monomer copolymerizable with vinyl chloride include α-olefins, such as ethylene, propylene, butylene, etc.; vinyl esters, such as vinyl acetate, vinyl propionate, etc.; vinyl ethers, such as butyl vinyl ether, cetyl vinyl ether, etc.; esters of (meth)acrylic acid, such as methyl (meth)acrylate, ethyl (meth)acrylate, phenyl (meth)acrylate, etc.; aromatic vinyl compounds, such as styrene, cx-methyl styrene, etc.; halogenated vinyl compounds, such as vinylidene chloride, vinyl fluoride, etc.; N-substituted maleimides, such as N-phenyl maleimide, N-cyclohexyl maleimide, etc.; and the like.

In addition, as the polymer other than the vinyl chloride copolymer, there may be used those polymers to which vinyl chloride is graft-copolymerizable. From the viewpoint of ensuring good availability, as the polymer other than the vinyl chloride copolymer, there may be mentioned, for example, an ethylene-vinyl acetate copolymer, an ethylene-vinyl acetate-carbon monoxide copolymer, an ethylene-ethyl acrylate copolymer, an ethylene-ethyl acrylate-carbon monoxide copolymer, an ethylene-methyl (meth)acrylate copolymer, an ethylene-propylene copolymer, an acrylonitrile-butadiene copolymer, a polyurethane and the like.

Of the aforementioned halogen-based resins, from the viewpoint of imparting good flexibility, etc., to the resin composition, preferred is at least one resin selected from the group consisting of a vinyl chloride-based resin, such as a vinyl chloride resin, an ethylene-vinyl chloride copolymer, a vinyl acetate-vinyl chloride copolymer, a polyurethane-grafted polyvinyl chloride copolymer, etc., a vinylidene chloride resin and a chloroprene rubber, more preferred is at least one resin selected from the group consisting of a vinyl chloride resin, a vinylidene chloride resin and a chloroprene rubber, and even more preferred is a vinyl chloride resin.

### [Plasticizer]

In the present invention, as the plasticizer, there may be used compounds that can be ordinarily used as a plasticizer for halogen-based resins. As such a plasticizer, from the viewpoint of attaining high compatibility of the plasticizer with the halogen-based resin, there may be mentioned those plasticizers whose SP value as measured by a Fedors method is preferably not less than 7.5 (cal/cm³)^{1/2}, more preferably not less than 8 (cal/cm³)^{1/2} and even more preferably not less than 8.5 (cal/cm³)^{1/2}, and is also preferably not more than 11.5 (cal/cm³)^{1/2}, more preferably not more than 11 (cal/cm³)^{1/2} and even more preferably not more than 10.5 (cal/cm³)^{1/2}. More specifically, the SP value of the plasticizer is preferably not less than 7.5 (cal/cm³)^{1/2} and not more than 11.5 (cal/cm³)^{1/2}, more preferably not less than 8 (cal/cm³)^{1/2} and not more than 11 (cal/cm³)^{1/2}, and even more preferably not less than 8.5 (cal/cm³)^{1/2} and not more than 10.5 (cal/cm³)^{1/2}.

Specific examples of the plasticizer include phthalic acid esters of a C₁ to C₁₃ alcohol, such as dioctyl phthalate (DOP), diisononyl phthalate (DINP), as well as dimethyl phthalate, diethyl phthalate, dibutyl phthalate, diundecyl phthalate, etc.; trimellitic acid esters of a C₆ to C₁₀ alcohol, such as tris(2-ethylhexyl) trimellitate, trioctyl trimellitate, tridecyl trimellitate, etc.; adipic acid esters; azelaic acid esters; sebacic acid esters; phosphoric acid esters; polyesters; epoxy-based compounds; fatty acid esters; pyromellitic acid esters; and the like, from the viewpoint of attaining high compatibility of the plasticizer with the halogen-based resin. These plasticizers may be used alone or in the form of a mixture of any two or more thereof. As the plasticizer, from the viewpoint of attaining high compatibility of the plasticizer with the halogen-based resin, preferred are phthalic acid esters or trimellitic acid esters of a C to C₂₀ alcohol, more preferred are phthalic acid esters or trimellitic acid esters of a C₅ to C₁₈ alcohol, and even more preferred are phthalic acid esters or trimellitic acid esters of a C₈ to C₁₃ alcohol.

The amount of the plasticizer compounded in the halogen-based resin composition in the production method of the present invention is preferably not less than 10 parts by mass, more preferably not less than 20 parts by mass and even more preferably not less than 30 parts by mass on the basis of 100 parts by mass of the halogen-based resin from the viewpoint of allowing the plasticizer to show good plasticizing effects for the halogen-based resin composition, and is also preferably not more than 170 parts by mass, more preferably not more than 160 parts by mass and even more preferably not more than 150 parts by mass on the basis of 100 parts by mass of the halogen-based resin from the viewpoint of improving processability of the halogen-based resin composition. More specifically, the amount of the plasticizer compounded in the halogen-based resin composition in the production method of the present invention is preferably not less than 10 parts by mass and not more than 170 parts by mass, more preferably not less than 20 parts by mass and not more than 160 parts by mass, and even more preferably not less than 30 parts by mass and not more than 150 parts by mass, on the basis of 100 parts by mass of the halogen-based resin.

### [Basic Inorganic Filler]

Examples of the basic inorganic filler used in the present invention include calcium carbonate, talc, calcium silicate, alumina and the like. These basic inorganic fillers may be used alone or in the form of a mixture of any two or more thereof. The basic inorganic filler preferably contains calcium carbonate, and is more preferably constituted of calcium carbonate, from the viewpoint of attaining good cost efficiency.

The amount of the basic inorganic filler compounded in the production method of the present invention is preferably not less than 1 part by mass, more preferably not less than 3 parts by mass and even more preferably not less than 5 parts by mass, and is also preferably not more than 150 parts by mass, more preferably not more than 140 parts by mass and even more preferably not more than 130 parts by mass, on the basis of 100 parts by mass of the halogen-based resin, from the viewpoint of reducing costs for the halogen-based resin composition. More specifically, the amount of the basic inorganic filler compounded in the production method of the present invention is preferably not less than 1 part by mass and not more than 150 parts by mass, more preferably not less than 3 parts by mass and not more than 140 parts by mass, and even more preferably not less than 5 parts by mass and not more than 130 parts by mass, on the basis of 100 parts by mass of the halogen-based resin.

### [Additives]

In the production method of the present invention, the halogen-based resin composition may be further compounded with various additives, such as a stabilizer, a processing aid, a colorant, an antioxidant, an ultraviolet absorber, an antistatic agent, a lubricant, etc., if required, as long as the advantageous effects of the present invention are adversely affected by inclusion of these additives.

Examples of the stabilizer include metal soap compounds, such as lithium stearate, magnesium stearate, magnesium laurate, calcium ricinolate, calcium stearate, barium laurate, barium ricinolate, barium stearate, zinc octylate, zinc laurate, zinc ricinolate, zinc stearate, etc.; organotin-based compounds, such as dimethyl tin bis-2-ethylhexyl thioglycolate, dibutyl tin maleate, dibutyl tin bis(butyl maleate), dibutyl tin dilaurate, etc.; antimony mercaptide compounds; and the like. The amount of the stabilizer compounded in the halogen-based resin composition is from 0.1 to 20 parts by mass on the basis of 100 parts by mass of the halogen-based resin.

Examples of the processing aid include liquid paraffin, a polyethylene wax, stearic acid, stearamide, ethylene bis(stearamide), butyl stearate, calcium stearate and the like. The amount of the processing aid compounded in the halogen-based resin composition is from 0.1 to 20 parts by mass on the basis of 100 parts by mass of the halogen-based resin.

Examples of the colorant include carbon black, lead sulfide, white carbon, titanium white, lithopone, red iron oxide, antimony sulfide, chrome yellow, chrome green, cobalt blue, molybdenum orange and the like. The amount of the colorant compounded in the halogen-based resin composition is from 1 to 100 parts by mass on the basis of 100 parts by mass of the halogen-based resin.

Examples of the antioxidant include phenol-based compounds, such as 2,6-di-tert-butyl phenol, tetrakis [methylene-3-(3,5-tert-butyl-4-hydroxy phenol) propionate]methane, 2-hydroxy-4-methoxy benzophenone, etc.; sulfur-based compounds, such as alkyl disulfides, thiodipropionic acid esters, benzothiazole, etc.; phosphoric acid-based compounds, such as trisnonylphenyl phosphite, diphenyl isodecyl phosphite, triphenyl phosphite, tris(2,4-di-tert-butylphenyl) phosphite, etc.; organometallic-based compounds, such as zinc dialkyl dithiophosphates, zinc diaryl dithiophosphates, etc.; and the like. The amount of the antioxidant compounded in the halogen-based resin composition is from 0.2 to 20 parts by mass on the basis of 100 parts by mass of the halogen-based resin.

Examples of the ultraviolet absorber include salicylate-based compounds, such as phenyl salicylate, p-tert-butyl phenyl salicylate, etc.; benzophenone-based compounds, such as 2-hydroxy-4-n-octoxy benzophenone, 2-hydroxy-4-n-methoxy benzophenone, etc.; benzotriazole-based compounds, such as 5-methyl-1H-benzotriazole, 1-dioctyl aminomethyl benzotriazole, etc.; cyanoacrylate-based compounds; and the like. The amount of the ultraviolet absorber compounded in the halogen-based resin composition is from 0.1 to 10 parts by mass on the basis of 100 parts by mass of the halogen-based resin.

Examples of the antistatic agent include anionic antistatic agents, such as alkyl sulfonate-type antistatic agents, alkyl ether carboxylic acid-type antistatic agents and dialkyl sulfosuccinate-type antistatic agents; nonionic antistatic agents, such as polyethylene glycol derivatives, sorbitan derivatives, diethanol amine derivatives, etc.; cationic antistatic agents, such as quaternary ammonium salts, e.g., alkyl amide amine-type antistatic agents, alkyl dimethyl benzyl-type antistatic agents, etc., organic acid salts or hydrochloric acid salts, e.g., alkyl pyridinium-type antistatic agents, etc.; amphoteric antistatic agents, such as alkyl betaine-type antistatic agents, alkyl imidazoline-type antistatic agents, etc.; and the like. The amount of the antistatic agent compounded in the halogen-based resin composition is from 0.1 to 10 parts by mass on the basis of 100 parts by mass of the halogen-based resin.

Examples of the lubricant include silicones, liquid paraffin, a paraffin wax, fatty acids, such as stearic acid, lauric acid, etc., and metal salts thereof, fatty acid amides, fatty acid waxes, higher fatty acid waxes and the like. The amount of the lubricant compounded in the halogen-based resin composition is from 0.1 to 10 parts by mass on the basis of 100 parts by mass of the halogen-based resin.

### [Halogen-Based Resin Composition]

The halogen-based resin composition obtained by the production method of the present invention contains the plasticizer, the anionic polymer, the basic inorganic filler and the halogen-based resin, and is characterized by its low slurry viscosity. The slurry viscosity of the halogen-based resin composition is preferably not more than 23 Pas, more preferably not more than 20 Pa·s and even more preferably not more than 17 Pas from the viewpoint of allowing the resin composition to exhibit excellent processability.

The slurry viscosity may be measured by the method described in Examples below.

The mixed powder or pellets of the halogen-based resin composition obtained by the production method of the present invention can be formed into a desired shape by conventionally known methods, such as extrusion molding, injection molding, calender molding, press molding, blow molding, etc. In addition, the paste-like halogen-based resin composition obtained by the production method of the present invention can be formed into a desired shape by conventionally known methods, such as spread molding, dipping molding, gravure molding, screen processing, etc.

The halogen-based resin composition produced by the production method of the present invention can exhibit excellent processability, and is therefore useful as housing interior materials, such as adhesives, sealants, paints, plastisol, foamed bodies, synthetic leather, pipes such as water pipes, etc., building materials, wall paper materials, floorings, floor covering materials, insulating materials, roof membrane materials, etc.; packaging materials, such as food packaging films, etc.; agricultural materials, such as agricultural films, etc.; automotive materials, such as sealing materials, undercoat materials, etc.; substrate protecting materials; cloth covering materials; sheathing materials for electric cables; various leather products; various foamed products; general-purpose hoses; gaskets; packing; boots; toys; food packaging materials; medical products, such as tubes, blood bags, etc.; and the like.

The present invention includes the following embodiments.
<1> A method for producing a halogen-based resin composition, including the following steps 1 to 3 in which the step 1 is first carried out:
   Step 1: mixing an anionic polymer and a plasticizer with each other;
   Step 2: further mixing a basic inorganic filler with a mixture obtained in the preceding step; and
   Step 3: further mixing a halogen-based resin with a mixture obtained in the preceding step.
<2> The method for producing a halogen-based resin composition according to the aforementioned aspect <1>, wherein the steps 1 to 3 are carried out in sequential order.
<3> The method for producing a halogen-based resin composition according to the aforementioned aspect <1> or <2>, wherein the mixing operation condition in the step 1 is not less than 250 rpm and not more than 3,500 rpm.
<4> The method for producing a halogen-based resin composition according to any one of the aforementioned aspects <1> to <3>, wherein the mixing time in the step 1 is not shorter than 2 minutes and 30 seconds and not longer than 3 minutes and 30 seconds.
<5> The method for producing a halogen-based resin composition according to any one of the aforementioned aspects <1> to <4>, wherein the mixing operation condition in the step 2 is not less than 3,000 rpm and not more than 7,000 rpm.
<6> The method for producing a halogen-based resin composition according to any one of the aforementioned aspects <1> to <5>, wherein the mixing time in the step 2 is not shorter than 2 minutes and 30 seconds and not longer than 3 minutes and 30 seconds.
<7> The method for producing a halogen-based resin composition according to any one of the aforementioned aspects <1> to <6>, wherein a slurry viscosity of a mixture of the anionic polymer, the plasticizer and the basic inorganic filler as measure at 25° C. after termination of the step 2 is not more than 10 Pas.
<8> The method for producing a halogen-based resin composition according to any one of the aforementioned aspects <1> to <7>, wherein a slurry viscosity of a mixture of the anionic polymer, the plasticizer, the basic inorganic filler and the halogen-based resin as measure at 25° C. after termination of the step 3 is not more than 17 Pa·s.
<9> The method for producing a halogen-based resin composition according to any one of the aforementioned aspects <1> to <8>, wherein the anionic polymer contains an anionic group-containing constitutional unit and a hydrophobic group-containing constitutional unit.
<10> The method for producing a halogen-based resin composition according to the aforementioned aspect <9>, wherein the anionic group-containing constitutional unit is a carboxy group-containing constitutional unit.
<11> The method for producing a halogen-based resin composition according to the aforementioned aspect <10>, wherein the carboxy group-containing constitutional unit is a constitutional unit derived from (meth)acrylic acid.
<12> The method for producing a halogen-based resin composition according to any one of the aforementioned aspects <9> to <11>, wherein the hydrophobic group-containing constitutional unit is at least one constitutional unit selected from the group consisting of those constitutional units derived from stearyl (meth)acrylate, lauryl (meth)acrylate, 2-ethylhexyl (meth)acrylate, stearoxypolyethylene glycol mono(meth)acrylate, lauroxypolyethylene glycol mono(meth)acrylate and 2-ethylhexyloxypropylene glycol polyethylene glycol mono(meth)acrylate.
<13> The method for producing a halogen-based resin composition according to any one of the aforementioned aspects <9> to <12>, wherein the anionic group-containing constitutional unit is the constitutional unit derived from methacrylic acid, the hydrophobic group-containing constitutional unit is the constitutional unit derived from stearyl (meth)acrylate, a content of the constitutional unit derived from methacrylic acid in whole constitutional units in the anionic polymer is not less than 5% by mass and not more than 20% by mass, and a content of the constitutional unit derived from stearyl (meth)acrylate in the whole constitutional units in the anionic polymer is not less than 15% by mass and not more than 60% by mass.
<14> The method for producing a halogen-based resin composition according to any one of the aforementioned aspects <9> to <12>, wherein the anionic group-containing constitutional unit is the constitutional unit derived from methacrylic acid, the hydrophobic group-containing constitutional unit is the constitutional unit derived from lauryl methacrylate, a content of the constitutional unit derived from methacrylic acid in whole constitutional units in the anionic polymer is not less than 40% by mass and not more than 60% by mass, and a content of the constitutional unit derived from lauryl methacrylate in the whole constitutional units in the anionic polymer is not less than 15% by mass and not more than 60% by mass.
<15> The method for producing a halogen-based resin composition according to any one of the aforementioned aspects to <12>, wherein the anionic group-containing constitutional unit is the constitutional unit derived from methacrylic acid, a content of the constitutional unit derived from methacrylic acid in whole constitutional units in the anionic polymer is not less than 5% by mass and not more than 20% by mass, the hydrophobic group-containing constitutional unit is the constitutional unit derived from 2-ethylhexyloxypropylene glycol polyethylene glycol methacrylate, and a content of the constitutional unit derived from 2-ethylhexyloxypropylene glycol polyethylene glycol methacrylate in the whole constitutional units in the anionic polymer is not less than 80% by mass and not more than 95% by mass.
<16> The method for producing a halogen-based resin composition according to any one of the aforementioned aspects <9> to <12>, wherein the anionic group-containing constitutional unit is the constitutional unit derived from methacrylic acid, a content of the constitutional unit derived from methacrylic acid in whole constitutional units in the anionic polymer is not less than 5% by mass and not more than 20% by mass, the hydrophobic group-containing constitutional unit is the constitutional unit derived from lauroxypolyethylene glycol monomethacrylate, and a content of the constitutional unit derived from lauroxypolyethylene glycol monomethacrylate in the whole constitutional units in the anionic polymer is not less than 80% by mass and not more than 95% by mass.
<17> The method for producing a halogen-based resin composition according to any one of the aforementioned aspects <9> to <12>, wherein the anionic group-containing constitutional unit is the constitutional unit derived from methacrylic acid, a content of the constitutional unit derived from methacrylic acid in whole constitutional units in the anionic polymer is not less than 10% by mass and not more than 20% by mass, the hydrophobic group-containing constitutional unit is the constitutional unit derived from 2-ethylhexyl methacrylate, and a content of the constitutional unit derived from 2-ethylhexyl methacrylate in the whole constitutional units in the anionic polymer is not less than 80% by mass and not more than 90% by mass.
<18> The method for producing a halogen-based resin composition according to any one of the aforementioned aspects <1> to <17>, wherein a weight-average molecular weight of the anionic polymer is not less than 4,000 and not more than 200,000.
<19> The method for producing a halogen-based resin composition according to any one of the aforementioned aspects <1> to <17>, wherein a weight-average molecular weight of the anionic polymer is not less than 5,000 and not more than 200,000.
<20> The method for producing a halogen-based resin composition according to any one of the aforementioned aspects <1> to <19>, wherein the anionic polymer is in an unneutralized state.
<21> The method for producing a halogen-based resin composition according to any one of the aforementioned aspects <1> to <20>, wherein an acid value of the anionic polymer is not less than 45 mgKOH/g and not more than 100 mgKOH/g.
<22> The method for producing a halogen-based resin composition according to any one of the aforementioned aspects <1> to <21>, wherein a mass ratio of the anionic polymer to the basic inorganic filler (anionic polymer/basic inorganic filler) is not less than 0.0001 and not more than 10.
<23> The method for producing a halogen-based resin composition according to any one of the aforementioned aspects <1> to <22>, wherein the mass ratio of the anionic polymer to the basic inorganic filler (anionic polymer/basic inorganic filler) is not less than 0.002 and not more than 0.01.
<24> The method for producing a halogen-based resin composition according to any one of the aforementioned aspects <1> to <23>, wherein the basic inorganic filler contains calcium carbonate.
<25> The method for producing a halogen-based resin composition according to any one of the aforementioned aspects <1> to <24>, wherein the halogen-based resin is a vinyl chloride resin.
<26> The method for producing a halogen-based resin composition according to any one of the aforementioned aspects <1> to <25>, wherein the plasticizer is a phthalic acid ester of an alcohol having not less than 8 and not more than 13 carbon atoms.
<27> The method for producing a halogen-based resin composition according to any one of the aforementioned aspects <1> to <26>, wherein an amount of the plasticizer compounded in the halogen-based resin composition is not less than 30 parts by mass and not more than 150 parts by mass on the basis of 100 parts by mass of the halogen-based resin.
<28> The method for producing a halogen-based resin composition according to any one of the aforementioned aspects <1> to <27>, wherein an amount of the basic inorganic filler compounded in the halogen-based resin composition is not less than 5 parts by mass and not more than 130 parts by mass on the basis of 100 parts by mass of the halogen-based resin.
<29> The method for producing a halogen-based resin composition according to any one of the aforementioned aspects <1> to <28>, wherein an amount of the anionic polymer compounded in the halogen-based resin composition is not less than 0.001% by mass and not more than 1.0% by mass.

### EXAMPLES

In the following Production Examples, Examples and Comparative Examples, the “part(s)” and “%” indicate “part(s) by mass” and “% by mass”, respectively, unless otherwise specified.

### [Measurement]

### [Method of Measuring Weight-Average Molecular Weight]

The weight-average molecular weight of the anionic polymer was measured by gel permeation chromatography (hereinafter also referred to as “GPC”).

That is, the synthesized anionic polymer was diluted with N,N-dimethylformamide to prepare a solution of the sample having a solid content of 0.3% by mass, and 100 μL of the thus prepared sample solution was subjected to the measurement. Using a solution prepared by dissolving phosphoric acid and lithium bromide in N,N-dimethylformamide such that concentrations of phosphoric acid and lithium bromide in the resulting solution were 60 mmol/L and 50 mmol/L, respectively, as an eluent, the measurement was conducted by GPC [apparatus: “HLC-8320GPC” available from Tosoh Corporation; detector: differential refractometer (attached to the apparatus); columns: “TSK-GEL, α-M” ×2 available from Tosoh Corporation; column temperature: 40° C.; flow rate of the eluent: 1 mL/min].

As reference standard substances for the measurement, there were used polystyrenes having molecular weights of 5.26×10², 1.02×10⁵ and 8.42×10⁶ available from Tosoh Corporation, and polystyrenes having molecular weights of 4.0×10³, 3.0×10⁴ and 9.0×10⁵ available from Nishio Industry Co., Ltd.

### [Method of Measuring Slurry Viscosity]

The viscosity of the halogen-based resin composition obtained by the production method of the present invention, or the mixture of the anionic polymer, the plasticizer and the basic inorganic filler obtained in the step 2 of the production method of the present invention, was measured using a rheometer “MCR-302” (tradename) available from Anton Paar GmbH. In the measurement, using a 25 mmp parallel plate as a jig, the sample was subjected to a shear rate sweep test at 25° C. in a shear rate range of from 0.1 s⁻¹ to 10 s⁻¹. The value of the viscosity of the sample as measured at a shear rate of 1 s⁻¹ was used as a slurry viscosity of the halogen-based resin composition.

### [Measurement of Bleed-Out Rate]

A molded sheet of the halogen-based resin composition was cut into a test piece (1.7 g) having a size of 4 cm×4 cm. One surface of the test piece was washed with 2 g of deuterated methanol containing 0.1% by weight of TMS, and the resulting deuterated methanol solution was subjected to 1H-NMR measurement to analyze the solution. The mass of the anionic polymer or surfactant in the deuterated methanol solution was determined from the integrated value of a peak derived from the anionic polymer or surfactant compounded in the halogen-based resin composition. Whereas, the amount of the anionic polymer or surfactant compounded in 1.7 g of the test piece was calculated from the amount of the anionic polymer or surfactant charged in the halogen-based resin composition. The bleed-out rate of the anionic polymer or surfactant was determined as a ratio (%) of the mass of the anionic polymer or surfactant in the deuterated methanol solution relative to the amount of the anionic polymer or surfactant compounded in the test piece. In this measuring method, the bleed-out rate of 0.2% by weight was still detectable, and “ND” (Not Detected) shown in Tables indicates that the bleed-out rate was less than 0.2% by weight.

### [Measurement of Solid Content]

Sodium sulfate dried to a constant weight in a desiccator was weighed and charged in an amount of 10.0 parts in a 30 mL glass petri dish, and about 1.0 g of a sample to be measured was added to the glass petri dish. The contents of the glass petri dish were mixed together and then accurately weighed. The resulting mixture was maintained in the glass petri dish at 105° C. for 2 hours to remove volatile components therefrom, and further allowed to stand in a desiccator for 15 minutes, followed by measuring a mass of the sample. The mass of the sample after removing the volatile components therefrom was regarded as a mass of solids in the sample. The solid content of the sample was calculated by dividing the mass of the solids by the mass of the sample initially added.

### Production of Anionic Polymer 1

### Production Example 1 (Production of Anionic Polymer 1)

A 1-L four-necked separable flask was charged with 7.9 g of stearyl methacrylate “NK ESTER S” (tradename) available from Shin-Nakamura Chemical Co., Ltd., 7.9 g of methacrylic acid available from FUJIFILM Wako Pure Chemical Corporation, 36.7 g of methoxypolyethylene glycol methacrylate “NK ESTER TM-230G” (tradename; 23 mol of EO added on average) available from Shin-Nakamura Chemical Co., Ltd., and 26.0 g of ethanol, and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 1.6 g of a polymerization initiator “V-65B” (tradename) available from FUJIFILM Wako Pure Chemical Corporation and 8.9 g of ethanol was added thereto. The resulting initial mixture was stirred for 10 minutes.

Next, while maintaining the temperature of the reaction system, a mixed solution of 31.5 g of stearyl methacrylate, 31.5 g of methacrylic acid, 148.8 g of the aforementioned methoxypolyethylene glycol methacrylate and 104.2 g of ethanol and a mixed solution of 6.3 g of the aforementioned polymerization initiator and 35.6 g of ethanol were separately added dropwise into the flask over 180 minutes (these mixed solutions are hereinafter referred to as “dropping mixtures” in Table 1). After completion of the dropwise addition, the resulting solution was stirred at 80° C. for 180 minutes, followed by cooling the solution to room temperature. The solid content of the thus obtained polymer solution was 60.1%. The resulting polymer solution was weighed in an amount of 10.0 g in a glass petri dish, and dried under reduced pressure at 80° C. for 3 hours, thereby obtaining an anionic polymer 1.

The weight-average molecular weight of the thus obtained anionic polymer 1 was 27,000.

### Production Example 2 (Production of Anionic Polymer 2)

Carboxy groups contained in the anionic polymer 1 were neutralized by adding 0.3 g of a 4N sodium hydroxide solution to 10.0 g of the polymer solution produced in Production Example 1 (solid components: 6.0 g; content of the constitutional unit derived from methacrylic acid in the polymer: 14.9%) and then stirring the obtained mixture for 30 minutes. The resulting polymer solution was dried under reduced pressure at 80° C. for 3 hours, thereby obtaining an anionic polymer 2 (a 10% neutralized product of the anionic polymer 1).

### Production Example 3 (Production of Anionic Polymer 3)

Carboxy groups contained in the anionic polymer 1 were neutralized by adding 0.6 g of a 4N sodium hydroxide solution to 10.0 g of the polymer solution produced in Production Example 1 (solid components: 6.0 g; content of the constitutional unit derived from methacrylic acid in the polymer: 14.9%) and then stirring the obtained mixture for 30 minutes. The resulting polymer solution was dried under reduced pressure at 80° C. for 3 hours, thereby obtaining an anionic polymer 3 (a 20% neutralized product of the anionic polymer 1).

### Production Example 4 (Production of Anionic Polymer 4)

Carboxy groups contained in the anionic polymer 1 were neutralized by adding 1.5 g of a 4N sodium hydroxide solution to 10.0 g of the polymer solution produced in Production Example 1 (solid components: 6.0 g; content of the constitutional unit derived from methacrylic acid in the polymer: 14.9%) and then stirring the obtained mixture for 30 minutes. The resulting polymer solution was dried under reduced pressure at 80° C. for 3 hours, thereby obtaining an anionic polymer 4 (a 50% neutralized product of the anionic polymer 1).

### Production Example 5 (Production of Anionic Polymer 5)

Carboxy groups contained in the anionic polymer 1 were neutralized by adding 3.0 g of a 4N sodium hydroxide solution to 10.0 g of the polymer solution produced in Production Example 1 (solid components: 6.0 g; content of the constitutional unit derived from methacrylic acid in the polymer: 14.9%) and then stirring the obtained mixture for 30 minutes. The resulting polymer solution was dried under reduced pressure at 80° C. for 3 hours, thereby obtaining an anionic polymer 5 (a 100% neutralized product of the anionic polymer 1).

### Production Example 6 (Production of Anionic Polymer 6)

A 1-L four-necked separable flask was charged with 20.3 g of stearyl acrylate, 6.8 g of methacrylic acid, 18.0 g of methoxypolyethylene glycol methacrylate “NK ESTER TM-230G” (tradename; 23 mol of EO added on average) available from Shin-Nakamura Chemical Co., Ltd., 1.8 g of mercaptopropanediol (polymerization chain transfer agent) available from FUJIFILM Wako Pure Chemical Corporation and 27.0 g of ethanol, and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 1.4 g of the aforementioned polymerization initiator and 11.3 g of ethanol was added thereto. The resulting initial mixture was stirred for 10 minutes.

Next, while maintaining the temperature of the reaction system, a mixed solution of 182.3 g of stearyl acrylate, 60.8 g of methacrylic acid, 162.0 g of the aforementioned methoxypolyethylene glycol methacrylate, 16.2 g of mercaptopropanediol and 143.0 g of ethanol and a mixed solution of 12.2 g of the aforementioned polymerization initiator and 100.0 g of ethanol were separately added dropwise into the flask over 180 minutes. After completion of the dropwise addition, the resulting solution was stirred at 80° C. for 180 minutes, followed by cooling the solution to room temperature. Then, 556.3 g of toluene and 275.3 g of ethanol were added to the solution to adjust a solid content thereof to 30.4%. The resulting polymer solution was weighed in an amount of 10.0 g in a glass petri dish, and dried under reduced pressure at 100° C. for 5 hours, thereby obtaining an anionic polymer 6.

The weight-average molecular weight of the thus obtained anionic polymer 6 was 5,800.

### Production Example 7 (Production of Anionic Polymer 7)

A 1-L four-necked separable flask was charged with 4.5 g of stearyl methacrylate, 1.5 g of methacrylic acid, 4.0 g of methoxypolyethylene glycol methacrylate “NK ESTER TM-230G” (tradename; 23 mol of EO added on average) available from Shin-Nakamura Chemical Co., Ltd., and 24.7 g of a toluene/ethanol mixed solution (mass ratio: 50/50), and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 0.02 g of the aforementioned polymerization initiator and 5.7 g of the toluene/ethanol mixed solution (mass ratio: 50/50) was added thereto, followed by continuously stirring the resulting mixture for 10 minutes.

Next, while maintaining the temperature of the reaction system, a mixed solution of 40.5 g of stearyl methacrylate, 13.5 g of methacrylic acid, 36.0 g of the aforementioned methoxypolyethylene glycol methacrylate and 42.1 g of the toluene/ethanol mixed solution (mass ratio: 50/50) and a mixed solution of 0.15 g of the aforementioned polymerization initiator and 50.9 g of the toluene/ethanol mixed solution (mass ratio: 50/50) were separately added dropwise into the flask over 120 minutes. After completion of the dropwise addition, the resulting solution was stirred at 80° C. for 120 minutes, followed by cooling the solution. The solid content of the thus obtained polymer solution was 45.2% by mass. The resulting polymer solution was weighed in an amount of 10.0 g in a glass petri dish, and dried under reduced pressure at 100° C. for 5 hours, thereby obtaining an anionic polymer 7.

The weight-average molecular weight of the thus obtained anionic polymer 7 was 166,000.

### Production Example 8 (Production of Anionic Polymer 8)

A 1-L four-necked separable flask was previously charged with 100.0 g of a toluene/ethanol mixed solution (mass ratio: 50/50), and two dropping funnels, a reflux condenser, a thermometer and a stirring device were fitted to the flask. After replacing an atmosphere of the reaction system with nitrogen, the mixed solution in the flask was heated to 80° C. while stirring. While maintaining the temperature of the reaction system, a mixed solution of 300.0 g of stearyl methacrylate, 75.0 g of methacrylic acid, 125.0 g of methoxypolyethylene glycol methacrylate “NK ESTER M-450G” (tradename; 45 mol of EO added on average) available from Shin-Nakamura Chemical Co., Ltd., 4.9 g of mercaptopropanediol and 350.4 g of the toluene/ethanol mixed solution (mass ratio: 50/50) and a mixed solution of 6.8 g of the aforementioned polymerization initiator and 49.6 g of the toluene/ethanol mixed solution (mass ratio: 50/50) were separately added dropwise into the flask over 120 minutes. After completion of the dropwise addition, the resulting solution was stirred at 80° C. for 60 minutes, followed by cooling the solution to room temperature. The solid content of the thus obtained polymer solution was 49.7%. The resulting polymer solution was weighed in an amount of 10.0 g in a glass petri dish, and dried under reduced pressure at 100° C. for 5 hours, thereby obtaining an anionic polymer 8. The content of a constitutional unit derived from an α,β-unsaturated carboxylic acid in the anionic polymer 8 was 15.0%.

The weight-average molecular weight of the thus obtained anionic polymer 8 was 14,300.

### Production Example 9 (Production of Anionic Polymer 9)

The same procedure as in Production Example 6 was repeated except that stearyl acrylate was replaced with stearyl methacrylate, and the amounts of the respective components compounded were changed to those shown in Table 1, thereby obtaining an anionic polymer 9.

The weight-average molecular weight of the thus obtained anionic polymer 9 was 8,600.

### Production Example 10 (Production of Anionic Polymer 10)

A 1-L four-necked separable flask was charged with 450.0 g of toluene, 224.0 g of diisobutylene available from FUJIFILM Wako Pure Chemical Corporation, 198.0 g of maleic anhydride available from FUJIFILM Wako Pure Chemical Corporation and 13.3 g of benzoyl peroxide (polymerization initiator) available from Tokyo Chemical Industry Co., Ltd., and a reflux condenser, a thermometer and a stirring device were fitted to the flask. After replacing an atmosphere of the reaction system with nitrogen, the contents of the flask were heated to 83° C. while stirring. While maintaining the temperature of the reaction system, the contents of the flask were reacted for 240 minutes. Then, the obtained reaction mixture was transferred to a vat coated with Teflon (trademark), and dried under reduced pressure at 100° C. for 5 hours. The weight-average molecular weight of the resulting polymer was 28,600.

Also, a 1-L four-necked separable flask was charged with 136.0 g of methyl isobutyl ketone and 24.8 g of the above-obtained solids (containing 0.12 mol of a constituent derived from maleic anhydride). After replacing an atmosphere of the reaction system with nitrogen, the solids were dissolved in the solvent at room temperature over 2 hours. Then, the resulting solution in the flask was heated up to 72° C. while stirring, and 32.0 g (0.12 mol) of stearyl amine “FARMIN 80” (tradename) available from Kao Corporation which had been previously molten at 80° C. was added to the solution. The obtained mixed solution was stirred at 72° C. for 120 minutes to subject the solution to amidation reaction, followed by cooling the obtained solution to room temperature. The solid content of the thus obtained polymer solution was 30.1%. The resulting polymer solution was weighed in an amount of 10.0 g in a glass petri dish, and dried under reduced pressure at 100° C. for 5 hours, thereby obtaining an anionic polymer 10.

Since the thus obtained anionic polymer 10 was insoluble in an eluent for GPC, the weight-average molecular weight of the anionic polymer 10 was calculated from the aforementioned GPC measured value. As a result of the calculation, the weight-average molecular weight of the anionic polymer 10 was 67,400.

### Production Example 11 (Production of Anionic Polymer 11)

A 1-L four-necked separable flask was charged with 8.5 g of 2-ethylhexyl methacrylate, 1.5 g of methacrylic acid, 0.13 g of mercaptopropanediol and 22.1 g of a toluene/ethanol mixed solution (mass ratio: 50/50), and two dropping funnels, a reflux condenser, a thermometer and a stirring device were fitted to the flask. After replacing an atmosphere of the reaction system with nitrogen, the contents of the flask were heated to 80° C. while stirring, and a mixed solution of 0.12 g of the aforementioned polymerization initiator and 5.9 g of the toluene/ethanol mixed solution (mass ratio: 50/50) was added thereto. The resulting initial mixture was stirred for 10 minutes.

Next, while maintaining the temperature of the reaction system, a mixed solution of 76.5 g of 2-ethylhexyl methacrylate, 13.5 g of methacrylic acid, 1.2 g of mercaptopropanediol and 19.2 g of the toluene/ethanol mixed solution (mass ratio: 50/50) and a mixed solution of 0.11 g of the aforementioned polymerization initiator and 52.8 g of the toluene/ethanol mixed solution (mass ratio: 50/50) were separately added dropwise into the flask over 120 minutes. After completion of the dropwise addition, the resulting solution was stirred at 80° C. for 120 minutes, followed by cooling the solution to room temperature. The resulting polymer solution was weighed in an amount of 10.0 g in a glass petri dish, and dried under reduced pressure at 100° C. for 5 hours, thereby obtaining an anionic polymer 11.

The weight-average molecular weight of the thus obtained anionic polymer 11 was 10,400.

Production Example 12 (Production of Anionic Polymer 12) The same procedure as in Production Example 11 was repeated except that 2-ethylhexyl methacrylate was replaced with 2-ethylhexyloxy polyethylene glycol polypropylene glycol methacrylate “BLEMMER 50POEP-800B” (tradename; 8 mol of EO added on average; 7 mol of PO added on average) available from NOF Corporation, the solvent was replaced with ethanol, and the amounts of the respective components compounded were changed to those shown in Table 1, thereby obtaining an anionic polymer 12.

The weight-average molecular weight of the thus obtained anionic polymer 12 was 7,700.

### Production Example 13 (Production of Anionic Polymer 13)

Carboxy groups contained in the anionic polymer 12 were neutralized by adding 2.00 g of a 4N sodium hydroxide solution to 10.0 g of the polymer solution produced in Production Example 12 (solid components: 4.0 g; content of the constitutional unit derived from methacrylic acid in the polymer: 15%) and then stirring the obtained mixture. The resulting polymer solution was dried under reduced pressure at 80° C., thereby obtaining an anionic polymer 13 (a 100% neutralized product of the anionic polymer 12).

### Production Example 14 (Production of Anionic Polymer 14)

The same procedure as in Production Example 11 was repeated except that 2-ethylhexyl methacrylate was replaced with 2-ethylhexyloxy polyethylene glycol polypropylene glycol methacrylate “BLEMMER 50POEP-800B” (tradename; 8 mol of EO added on average; 7 mol of PO added on average) available from NOF Corporation, the solvent was replaced with ethanol, and the amounts of the respective components compounded were changed to those shown in Table 1, thereby obtaining an anionic polymer 14.

The weight-average molecular weight of the thus obtained anionic polymer 14 was 8,700.

### Production Example 15 (Production of Anionic Polymer 15)

The same procedure as in Production Example 11 was repeated except that 2-ethylhexyl methacrylate was replaced with lauroxy polyethylene glycol methacrylate “BLEMMER PLE200” (tradename; 4 mol of EO added on average) available from NOF Corporation, and the amounts of the respective components compounded were changed to those shown in Table 1, thereby obtaining an anionic polymer 15.

The weight-average molecular weight of the thus obtained anionic polymer 15 was 16,400.

### Production Example 16 (Production of Anionic Polymer 16)

The same procedure as in Production Example 11 was repeated except that 2-ethylhexyl methacrylate was replaced with 2-ethylhexyloxy polyethylene glycol polypropylene glycol methacrylate “BLEMMER 50POEP-800B” (tradename; 8 mol of EO added on average; 7 mol of PO added on average) available from NOF Corporation, the solvent was replaced with ethanol, and the amounts of the respective components compounded were changed to those shown in Table 1, thereby obtaining an anionic polymer 16.

The weight-average molecular weight of the thus obtained anionic polymer 16 was 27,100.

### Production Example 17 (Production of Anionic Polymer 17)

The same procedure as in Production Example 6 was repeated except that stearyl acrylate was replaced with lauryl methacrylate, the solvent was replaced with a toluene/ethanol mixed solution (mass ratio: 50/50), and the amounts of the respective components compounded were changed to those shown in Table 1, thereby obtaining an anionic polymer 17.

The weight-average molecular weight of the thus obtained anionic polymer 17 was 17,400.

### Production Example 18 (Production of Anionic Polymer 18)

The same procedure as in Production Example 6 was repeated except that stearyl acrylate was replaced with lauryl methacrylate, and the amounts of the respective components compounded were changed to those shown in Table 1, thereby obtaining an anionic polymer 18.

The weight-average molecular weight of the thus obtained anionic polymer 18 was 15,200.

TABLE 1

| Production Examples | | 1 | 6 | 7 | 8 | 9 | 11 | 12 | 14 | 15 | 16 | 17 | 18 |
|---|---|---|---|---|---|---|---|---|---|---|---|---|---|
| Kind of anionic polymer | | 1 | 6 | 7 | 8 | 9 | 11 | 12 | 14 | 15 | 16 | 17 | 18 |
| Initial | Methacrylic acid | 7.9 | 6.8 | 1.5 | | 3.4 | 1.5 | 3.0 | 1.5 | 1.5 | 0.5 | 0.8 | 1.5 |
| mixture | Stearyl acrylate | | 20.3 | | | | | | | | | | |
| | Stearyl methacrylate | 7.9 | | 4.5 | | 20.3 | | | | | | | |
| | Lauryl methacrylate | | | | | | | | | | | 5.3 | 4.5 |
| | Methoxy PEG23 methacrylate*¹ | 36.7 | 18.0 | 4.0 | | 21.4 | | | | | | 4.0 | 4.0 |
| | 2EHMA*³ | | | | | | 8.5 | | | | | | |
| | PLE200*⁴ | | | | | | | | | 8.5 | | | |
| | 50POEP-800B*⁵ | | | | | | | 17.0 | 18.5 | | 9.5 | | |
| | Mercaptopropanediol | | 1.8 | | | 0.9 | 0.13 | 0.7 | 0.5 | 0.08 | 0.09 | 0.07 | 0.10 |
| | Toluene/ethanol (1/1) | | | 24.7 | 100.0 | | 22.1 | | | 20.7 | | 15.8 | |
| | Ethanol | 26.0 | 27.0 | | | 27.0 | | 74.0 | 74.0 | | 13.9 | | 15.3 |
| | Polymerization initiator | 1.6 | 1.4 | 0.02 | | 0.5 | 0.12 | 0.6 | 0.4 | 0.07 | 0.08 | 0.06 | 0.07 |
| | Toluene/ethanol (1/1) | | | 5.7 | | | 5.9 | | | 7.3 | | 2.8 | |
| | Ethanol | 8.9 | 11.3 | | | 11.3 | | 10.0 | 10.0 | | 4.7 | | 3.3 |

| Production Examples | | 1 | 6 | 7 | 8 | 9 | 11 | 12 | 14 | 15 | 16 | 17 | 18 |
|---|---|---|---|---|---|---|---|---|---|---|---|---|---|
| Dropping | Methacrylic acid | 31.5 | 60.8 | 13.5 | 75.0 | 30.4 | 13.5 | 27.0 | 13.5 | 13.5 | 4.5 | 6.8 | 13.5 |
| mixtures | Stearyl acrylate | | 182.3 | | | | | | | | | | |
| | Stearyl methacrylate | 31.5 | | 40.5 | 300.0 | 182.3 | | | | | | | |
| | Lauryl methacrylate | | | | | | | | | | | 47.3 | 40.5 |
| | Methoxy PEG23 methacrylate*¹ | 148.8 | 162.0 | 36.0 | | 192.4 | | | | | | 36.0 | 36.0 |
| | Methoxy PEG45 methacrylate*² | | | | 125.0 | | | | | | | | |
| | 2EHMA*³ | | | | | | 76.5 | | | | | | |
| | PLE200*⁴ | | | | | | | | | 76.5 | | | |
| | 50POEP-800B*⁵ | | | | | | | 153.0 | 166.5 | | 85.5 | | |
| | Mercaptopropanediol | | 16.2 | | 4.9 | 8.1 | 1.2 | 6.5 | 4.9 | 0.72 | 0.80 | 0.64 | 0.90 |
| | Toluene/ethanol (1/1) | | | 42.1 | 350.4 | | 19.2 | | | 6.2 | | 22.8 | |
| | Ethanol | 104.2 | 143.0 | | | 143.0 | | 126.0 | 126.2 | | 5.7 | | 18.4 |
| | Polymerization initiator | 6.3 | 12.2 | 0.15 | 6.8 | 4.1 | 0.11 | 5.0 | 3.7 | 0.67 | 0.73 | 0.51 | 0.60 |
| | Toluene/ethanol (1/1) | | | 50.9 | 49.6 | | 52.8 | | | 65.8 | | 25.3 | |
| | Ethanol | 35.6 | 100.0 | | | 100.0 | | 90.0 | 89.8 | | 42.3 | | 29.7 |

| | | | | | | | | | | | | |
|---|---|---|---|---|---|---|---|---|---|---|---|---|
| Content of hydrophobic monomers (% by mass)*⁶ | 15.0 | 45.0 | 45.0 | 60.0 | 45.0 | 85.0 | 85.0 | 92.5 | 85.0 | 95.0 | 52.5 | 45.0 |

In Table 1, the numerical values of the respective components are on the basis of a mass (g) thereof.
*¹Methoxypolyethylene glycol methacrylate “NK ESTER TM-230G” (tradename; 23 mol of EO added on average) available from Shin-Nakamura Chemical Co., Ltd.
*²Methoxypolyethylene glycol methacrylate “NK ESTER TM-450G” (tradename; 45 mol of EO added on average) available from Shin-Nakamura Chemical Co., Ltd.
*³2-Ethylhexyl methacrylate
*⁴Lauroxy polyethylene glycol methacrylate “BLEMMER PLE200” (tradename) available from NOF Corporation
*⁵2-Ethylhexyloxy polypropylene glycol polyethylene glycol methacrylate “BLEMMER 50POEP-800B” (tradename) available from NOF Corporation
*⁶Content of hydrophobic group-containing constitutional units in the anionic polymer

The raw material monomers used in Production Examples 1 to 18 as well as the weight-average molecular weights, acid values and neutralization degrees of the anionic polymers 1 to 18 produced therein are collectively shown in Table 2.

TABLE 2

| Production Examples | | 1 | 2 | 3 | 4 | 5 | 6 | 7 | 8 | 9 |
|---|---|---|---|---|---|---|---|---|---|---|
| Kind of anionic polymer | | 1 | 2 | 3 | 4 | 5 | 6 | 7 | 8 | 9 |
| Monomers | Methacrylic acid | 14.9 | 14.9 | 14.9 | 14.9 | 14.9 | 15.0 | 15.0 | 15.0 | 7.5 |
| | Stearyl acrylate | 0.0 | 0.0 | 0.0 | 0.0 | 0.0 | 45.0 | 0.0 | 0.0 | 0.0 |
| | Stearyl methacrylate | 14.9 | 14.9 | 14.9 | 14.9 | 14.9 | 0.0 | 45.0 | 60.0 | 45.0 |
| | Lauryl methacrylate | 0.0 | 0.0 | 0.0 | 0.0 | 0.0 | 0.0 | 0.0 | 0.0 | 0.0 |
| | Methoxy PEG23 methacrylate*¹ | 70.2 | 70.2 | 70.2 | 70.2 | 70.2 | 40.0 | 40.0 | 0.0 | 47.5 |
| | Methoxy PEG45 methacrylate*² | 0.0 | 0.0 | 0.0 | 0.0 | 0.0 | 0.0 | 0.0 | 25.0 | 0.0 |
| | 2EHMA*³ | 0.0 | 0.0 | 0.0 | 0.0 | 0.0 | 0.0 | 0.0 | 0.0 | 0.0 |
| | PLE200*⁴ | 0.0 | 0.0 | 0.0 | 0.0 | 0.0 | 0.0 | 0.0 | 0.0 | 0.0 |
| | 50POEP-800B*⁵ | 0.0 | 0.0 | 0.0 | 0.0 | 0.0 | 0.0 | 0.0 | 0.0 | 0.0 |
| | Monostearyl maleate | 0.0 | 0.0 | 0.0 | 0.0 | 0.0 | 0.0 | 0.0 | 0.0 | 0.0 |
| | Diisobutylene | 0.0 | 0.0 | 0.0 | 0.0 | 0.0 | 0.0 | 0.0 | 0.0 | 0.0 |

| | | | | | | | | | |
|---|---|---|---|---|---|---|---|---|---|
| Weight-average molecular weight | 27,000 | 27,000 | 27,000 | 27,000 | 27,000 | 5,800 | 166,000 | 14,300 | 8,600 |
| Acid value (mgKOH/g) | 94.4 | 94.4 | 94.4 | 94.4 | 94.4 | 92.1 | 101.8 | 97.6 | 48.3 |
| Neutralization degree (mol %) | Unneu- | 10 | 20 | 50 | 100 | Unneu- | Unneu- | Unneu- | Unneu- |
| | tralized | | | | | tralized | tralized | tralized | tralized |

| Production Examples | | 10 | 11 | 12 | 13 | 14 | 15 | 16 | 17 | 18 |
|---|---|---|---|---|---|---|---|---|---|---|
| Kind of anionic polymer | | 10 | 11 | 12 | 13 | 14 | 15 | 16 | 17 | 18 |
| Monomers | Methacrylic acid | 0.0 | 15.0 | 15.0 | 15.0 | 7.5 | 15.0 | 5.0 | 7.5 | 15.0 |
| | Stearyl acrylate | 0.0 | 0.0 | 0.0 | 0.0 | 0.0 | 0.0 | 0.0 | 0.0 | 0.0 |
| | Stearyl methacrylate | 0.0 | 0.0 | 0.0 | 0.0 | 0.0 | 0.0 | 0.0 | 0.0 | 0.0 |
| | Lauryl methacrylate | 0.0 | 0.0 | 0.0 | 0.0 | 0.0 | 0.0 | 0.0 | 52.5 | 45.0 |
| | Methoxy PEG23 methacrylate*¹ | 0.0 | 0.0 | 0.0 | 0.0 | 0.0 | 0.0 | 0.0 | 40.0 | 40.0 |
| | Methoxy PEG45 methacrylate*² | 0.0 | 0.0 | 0.0 | 0.0 | 0.0 | 0.0 | 0.0 | 0.0 | 0.0 |
| | 2EHMA*³ | 0.0 | 85.0 | 0.0 | 0.0 | 0.0 | 0.0 | 0.0 | 0.0 | 0.0 |
| | PLE200*⁴ | 0.0 | 0.0 | 0.0 | 0.0 | 0.0 | 85.0 | 0.0 | 0.0 | 0.0 |
| | 50POEP-800B*⁵ | 0.0 | 0.0 | 85.0 | 85.0 | 92.5 | 0.0 | 95.0 | 0.0 | 0.0 |
| | Monostearyl maleate | 75.0 | 0.0 | 0.0 | 0.0 | 0.0 | 0.0 | 0.0 | 0.0 | 0.0 |
| | Diisobutylene | 25.0 | 0.0 | 0.0 | 0.0 | 0.0 | 0.0 | 0.0 | 0.0 | 0.0 |

| | | | | | | | | | |
|---|---|---|---|---|---|---|---|---|---|
| Weight-average molecular weight | 67,400 | 10,400 | 7,700 | 7,700 | 8,700 | 16,400 | 27,100 | 17,400 | 15,200 |
| Acid value (mgKOH/g) | 114.4 | 99.0 | 93.8 | 93.8 | 47.0 | 98.0 | 31.3 | 30.2 | 59.0 |
| Neutralization degree (mol %) | Unneu- | Unneu- | Unneu- | 100 | Unneu- | Unneu- | Unneu- | Unneu- | Unneu- |
| | tralized | tralized | tralized | | tralized | tralized | tralized | tralized | tralized |

*¹Methoxypolyethylene glycol methacrylate “NK ESTER TM-230G” (tradename; 23 mol of EO added on average) available from Shin-Nakamura Chemical Co., Ltd.
*²Methoxypolyethylene glycol methacrylate “NK ESTER TM-450G” (tradename; 45 mol of EO added on average) available from Shin-Nakamura Chemical Co., Ltd.
*³2-Ethylhexyl methacrylate
*⁴Lauroxy polyethylene glycol methacrylate “BLEMMER PLE200” (tradename) available from NOF Corporation
*⁵2-Ethylhexyloxy polypropylene glycol polyethylene glycol methacrylate “BLEMMER 50POEP-800B” (tradename) available from NOF Corporation

### Production of Halogen-Based Resin Composition for Measurement of Slurry Viscosity

### Example 1-1

The anionic polymer 2 in an amount of 0.2 g (corresponding to 0.5% in terms of a concentration of the anionic polymer relative to a mass of calcium carbonate) was mixed with 55.0 g of a plasticizer (bis(2-ethylhexyl) phthalate) available from FUJIFILM Wako Pure Chemical Corporation using a magnetic stirrer at a rotating speed of 300 rpm for 3 minutes. The resulting mixture and 40.0 g of calcium carbonate “WHITE H” (tradename) available from Shiraishi Calcium Kaisha Ltd., were charged into a 500 mL plastic cup, and mixed together using a Labomixer at a rotating speed of 5,000 rpm for 3 minutes. The resulting mixture of the anionic polymer 2, the plasticizer and calcium carbonate was homogeneously mixed with 40.0 g of a vinyl chloride resin “PSL-675” (tradename; average polymerization degree: 800) available from Kaneka Corporation using a spatula. Thereafter, the resulting mixture was mixed using a Labomixer at a rotating speed of 5,000 rpm for 3 minutes. Then, the obtained mixture was allowed to stand under reduced pressure for 10 minutes to subject the mixture to defoaming, thereby obtaining a halogen-based resin composition. The slurry viscosity of the thus obtained halogen-based resin composition as measured at 25° C. was 14 Pa·s.

### Examples 1-2 to 1-6

The same procedure as in Example 1-1 was repeated except that the anionic polymer and the concentration of the anionic polymer relative to calcium carbonate were changed to those shown in Table 3, thereby producing halogen-based resin compositions. The slurry viscosities of the thus obtained halogen-based resin compositions as measured at 25° C. were shown in Table 3.

### Example 1-7

The same procedure as in Production Example 9 was repeated except that no drying under reduced pressure was carried out, thereby producing the ethanol solution of the anionic polymer 9 prior to subjecting the polymer solution to the drying under reduced pressure. The ethanol solution of the anionic polymer 9 in an amount of 0.33 g (solid content: 61.3%; corresponding to 0.5% in terms of a concentration of the anionic polymer relative to a mass of calcium carbonate), and 55.0 g of a plasticizer (bis(2-ethylhexyl) phthalate) available from FUJIFILM Wako Pure Chemical Corporation were charged into a 1-L four-necked flask. The contents of the flask were allowed to stand at 160° C. under reduced pressure at 6 torr or less for 1 hour while stirring at 200 rpm and blowing nitrogen gas thereinto to thereby remove the solvent therefrom. The resulting mixture, 40.0 g of calcium carbonate “WHITE H” (tradename) available from Shiraishi Calcium Kaisha Ltd., and 40.0 g of a vinyl chloride resin “PSL-675” (tradename; average polymerization degree: 800) available from Kaneka Corporation were sequentially charged into a 500 mL plastic cup in this order, and homogeneously mixed with each other using a spatula. Thereafter, the resulting mixture was mixed using a Labomixer at a rotating speed of 5,000 rpm for 3 minutes. Then, the obtained mixture was allowed to stand under reduced pressure for 10 minutes to subject the mixture to defoaming, thereby obtaining a halogen-based resin composition. The slurry viscosity of the thus obtained halogen-based resin composition as measured at 25° C. was 12 Pa·s. The results are shown in Table 3.

### Example 1-8

The same procedure as in Production Example 12 was repeated except that no drying under reduced pressure was carried out, thereby producing the ethanol mixed solution of the anionic polymer 12 prior to subjecting the polymer solution to the drying under reduced pressure. Then, the same procedure as in Example 1-7 was repeated except that the solution of the anionic polymer 9 was replaced with 0.50 g of the solution of the anionic polymer 12 (solid content: 40.4%; corresponding to 0.5% in terms of a concentration of the anionic polymer relative to a mass of calcium carbonate), thereby producing a halogen-based resin composition. The slurry viscosity of the thus obtained halogen-based resin composition as measured at 25° C. was 13 Pa·s. The results are shown in Table 3.

### Example 1-9

The same procedure as in Production Example 15 was repeated except that no drying under reduced pressure was carried out, thereby producing the toluene/ethanol mixed solution of the anionic polymer 15 prior to subjecting the polymer solution to the drying under reduced pressure. Then, the same procedure as in Example 1-7 was repeated except that the solution of the anionic polymer 9 was replaced with 0.33 g of the solution of the anionic polymer 15 (solid content: 59.9%; corresponding to 0.5% in terms of a concentration of the anionic polymer relative to a mass of calcium carbonate), thereby producing a halogen-based resin composition. The slurry viscosity of the thus obtained halogen-based resin composition as measured at 25° C. was 14 Pas. The results are shown in Table 3.

### Comparative Example 1-1

The same procedure as in Example 1-1 was repeated except that no anionic polymer 2 was used, thereby producing a halogen-based resin composition. The slurry viscosity of the thus obtained halogen-based resin composition as measured at 25° C. was 36 Pa·s. Comparative Examples 1-2 to 1-4

The same procedure as in Example 1-1 was repeated except that the anionic polymer 2 was replaced with a surfactant “EXCEL S-95” (tradename; glycerin monostearate) available from Kao Corporation, and the concentration of the surfactant relative to a mass of calcium carbonate was changed to those shown in Table 3, thereby producing halogen-based resin compositions. The slurry viscosities of the thus obtained halogen-based resin compositions as measured at 25° C. are shown in Table 3.

TABLE 3

| | | | | Evaluation |
|---|---|---|---|---|
| | | Anionic polymer, etc. | | results |
| | | | Concentration | Slurry viscosity |
| | | Kind | (% by mass)*¹ | (Pa · s) |
| Examples | 1-1 | 2 | 0.5 | 14 |
| | 1-2 | 5 | 0.5 | 9 |
| | 1-3 | 6 | 0.5 | 10 |
| | 1-4 | 12 | 0.5 | 14 |
| | 1-5 | | 0.25 | 10 |
| | 1-6 | 13 | 0.5 | 9 |
| | 1-7 | 9 | 0.5 | 12 |
| | 1-8 | 12 | 0.5 | 13 |
| | 1-9 | 15 | 0.5 | 14 |
| Comparative | 1-1 | — | — | 36 |
| Examples | 1-2 | Glycerin | 0.5 | 27 |
| | 1-3 | monostearyl*² | 1.0 | 27 |
| | 1-4 | | 2.5 | 25 |

*¹Concentration of the anionic polymer, etc., relative to a mass of calcium carbonate
*²“EXCEL S-95” (tradename) available from Kao Corporation

### Production of Halogen-Based Resin Composition for Measurement of Bleed-Out Rate

### Example 2-1

### (Production of Halogen-Based Resin Composition)

The anionic polymer 2 in an amount of 0.1 g (corresponding to 0.5% in terms of a concentration of the anionic polymer relative to a mass of calcium carbonate) was mixed with 60 g of a plasticizer (bis(2-ethylhexyl) phthalate) available from FUJIFILM Wako Pure Chemical Corporation using a magnetic stirrer at a rotating speed of 300 rpm for 3 minutes. The resulting mixture and 20 g of calcium carbonate “WHITE H” (tradename) available from Shiraishi Calcium Kaisha Ltd., were mixed together using a Labomixer at a rotating speed of 5000 rpm for 3 minutes. The resulting mixture of the anionic polymer 2, the plasticizer and calcium carbonate, 100 g of a vinyl chloride resin “ZEST1400” (tradename; average polymerization degree: 1400) available from Shin Dai-Ichi Vinyl Corporation, 2 g of a Ca/Mg/Zn-based stabilizer for vinyl chloride resins “ADEKA STAB RUP-103” (tradename) available from ADEKA Corporation and 0.5 g of a lubricant “LUNAC S-70V” (tradename) available from Kao Corporation were mixed with each other at room temperature using a stirring rod. Thereafter, the resulting mixture was mixed and gelled at a rotating speed of 17.5 rpm at 160° C. using a 4-inch open roll-type kneader available from Nishimura Machinery Co., Ltd., followed by continuously mixing the mixture for 10 minutes after the gelling, thereby obtaining a halogen-based resin composition.

### (Production of Molded Sheet)

The halogen-based resin composition obtained above was successively pressed at 175° C. under a pressure of 0.5 MPa for 5 minutes and then under a pressure of 20 MPa for 2 minutes, and further at 15° C. under a pressure of 0.5 MPa for 2 minutes, thereby obtaining a resin molded sheet having a thickness of 0.8 mm. No bleed-out of the anionic polymer 2 from the thus obtained resin molded sheet was detected. The results are shown in Table 4.

### Examples 2-2 to 2-6

The same procedure as in Example 2-1 was repeated except that the anionic polymer and the concentration of the anionic polymer relative to calcium carbonate were changed to those shown in Table 4, thereby obtaining molded sheets of halogen-based resin compositions. No bleed-out of the anionic polymer from the thus obtained respective resin molded sheets was detected. The results are shown in Table 4.

### Comparative Examples 2-1 to 2-3

The same procedure as in Example 2-1 was repeated except that the anionic polymer 2 was replaced with a surfactant “EXCEL S-95” (tradename; glycerin monostearate) available from Kao Corporation, and the concentration of the surfactant relative to calcium carbonate was changed to those shown in Table 4, thereby obtaining resin molded sheets. The bleed-out rate of the surfactant from the thus obtained respective resin molded sheets was calculated. The results are shown in Table 4.

TABLE 4

| | | | | Evaluation |
|---|---|---|---|---|
| | | Anionic polymer, etc. | | results |
| | | | Concentration | Bleed-out rate |
| | | Kind | (% by mass)*¹ | (% by mass) |
| Examples | 2-1 | 2 | 0.5 | ND*³ |
| | 2-2 | 5 | 0.5 | ND |
| | 2-3 | 6 | 0.5 | ND |
| | 2-4 | 12 | 0.5 | ND |
| | 2-5 | | 0.25 | ND |
| | 2-6 | 13 | 0.5 | ND |
| Comparative | 2-1 | Glycerin | 0.5 | ND |
| Examples | 2-2 | monostearyl*² | 1.0 | 20 |
| | 2-3 | | 2.5 | 33 |

*¹Concentration of the anionic polymer, etc., relative to a mass of calcium carbonate
*²“EXCEL S-95” (tradename) available from Kao Corporation
*³ND indicates that the bleed-out rate was below the detection limit.

As shown in Table 3, from the results of Examples 1-1 to 1-9 and Comparative Example 1-1, it was confirmed that when using the anionic polymers, the resulting halogen-based resin compositions exhibited a reduced slurry viscosity, and were improved in processability.

In addition, as shown in Tables 3 and 4, from the results of Examples 1-1 to 1-9, Examples 2-1 to 2-6, Comparative Examples 1-2 to 1-4 and Comparative Examples 2-1 to 2-3, the surfactant containing no anionic group, such as glycerin monostearyl, served to reduce a slurry viscosity of the respective halogen-based resin compositions to some extent, but failed to reduce the slurry viscosity sufficiently enough to improve processability thereof. Furthermore, it was confirmed that when the concentration of the glycerin monostearyl relative to calcium carbonate was increased to a predetermined value or more, the glycerin monostearyl was bled-out from the halogen-based resin compositions. The reason therefor was considered to be that in such a case, adsorption of the glycerin monostearyl onto calcium carbonate as the basic inorganic filler was insufficient.

From the results of Examples 1˜4 and 1-8, it was confirmed that in any of the case where the steps 2 and 3 were sequentially carried out in this order after the step 1 and the case where the steps 2 and 3 were carried out at the same time after the step 1, the slurry viscosities of the halogen-based resin compositions obtained in both the cases were almost identical to each other.

Also, from the results of Examples 1-1, 1-2 and 1-6, it was confirmed that even in the case where the neutralized anionic polymers were used, when the respective components were added in the sequential order to produce the halogen-based resin compositions, it was possible to reduce the slurry viscosities of the resulting halogen-based resin compositions. As a result, it is considered that by conducting the method for producing the halogen-based resin composition according to the present invention in which the respective components are added in the sequential order, both an unneutralized anionic polymer and a neutralized anionic polymer are effectively usable therein, and it is therefore possible to produce halogen-based resin compositions using a larger variety of kinds of anionic polymers.

In addition, as shown in Examples 1-1 to 1-6, according to the production method of the present invention, by adding calcium carbonate as the basic inorganic filler to the mixture of the plasticizer and the anionic polymer, it was possible to render the surface of the basic inorganic filler homogeneously hydrophobic, and further by adding the halogen-based resin to the mixture, it was possible to produce the halogen-based resin compositions even in a short process. In the Examples described in the Patent Literature 2, the slurry was dried at 105° C. for 24 hours in order to obtain the calcium carbonate powder coated with the anionic polymer. On the other hand, according to the production method of the present invention, in comparison with the production method described in the Patent Literature 2, it was unnecessary to use the basic inorganic filler in the form of a water dispersion thereof for the purpose of precipitating the filler along with the neutralized surfactant, and it was also unnecessary to subject the water dispersion of the basic organic filler to filtration and drying in order to produce the halogen-based resin composition. Therefore, the production method of the present invention shows high production efficiency.

### Measurement of Slurry Viscosity of Mixture

### Example 3-1

The anionic polymer 1 in an amount of 0.4 g (corresponding to 0.5% in terms of a concentration of the anionic polymer relative to a mass of calcium carbonate) was mixed with 40.0 g of the plasticizer using a magnetic stirrer at a rotating speed of 300 rpm for 3 minutes. The resulting mixture and 85.0 g of calcium carbonate “WHITE H” (tradename) available from Shiraishi Calcium Kaisha Ltd., were mixed together using a Labomixer at a rotating speed of 5,000 rpm for 3 minutes. Then, the resulting mixture was allowed to stand at room temperature under reduced pressure for 10 minutes to subject the mixture to defoaming, thereby obtaining a mixture of the anionic polymer 1, the plasticizer and calcium carbonate. The slurry viscosity of the thus obtained mixture as measured at 25° C. was 9.0 Pa·s.

### Examples 3-2 to 3-17 and Comparative Examples 3-1 to 3-3

The same procedure as in Example 3-1 was repeated except that the kind of anionic polymer or surfactant and the concentration of the anionic polymer or surfactant relative to calcium carbonate were changed to those shown in Table 5, thereby preparing mixtures, and the slurry viscosities of the thus obtained respective mixtures were measured at 25° C. The results are shown in Table 5.

### Comparative Example 3-4

The same procedure as in Example 3-1 was repeated except that no anionic polymer 1 was used, thereby obtaining a mixture of the plasticizer and calcium carbonate. The slurry viscosity of the thus obtained mixture as measured at 25° C. was 104.0 Pa·s.

TABLE 5

| | | | | Evaluation |
|---|---|---|---|---|
| | | Anionic polymer, etc. | | results |
| | | | Concentration | Slurry viscosity |
| | | Kind | (% by mass)*¹ | (Pa · s) |
| Examples | 3-1 | 1 | 0.5 | 9.0 |
| | 3-2 | 6 | 0.25 | 1.1 |
| | 3-3 | | 0.5 | 1.0 |
| | 3-4 | 7 | 0.5 | 3.2 |
| | 3-5 | 8 | 0.5 | 4.4 |
| | 3-6 | 9 | 0.25 | 1.0 |
| | 3-7 | | 0.5 | 1.0 |
| | 3-8 | 10 | 0.5 | 8.0 |
| | 3-9 | 11 | 0.5 | 9.3 |
| | 3-10 | 12 | 0.25 | 0.9 |
| | 3-11 | | 0.5 | 0.9 |
| | 3-12 | 14 | 0.25 | 0.9 |
| | 3-13 | | 0.5 | 0.9 |
| | 3-14 | 15 | 0.5 | 1.2 |
| | 3-15 | 16 | 0.5 | 0.8 |
| | 3-16 | 17 | 0.5 | 1.2 |
| | 3-17 | 18 | 0.5 | 10.4 |
| Comparative | 3-1 | Glycerin | 0.5 | 88.0 |
| Examples | 3-2 | monostearyl*² | 1.0 | 40.0 |
| | 3-3 | | 2.5 | 32.0 |
| | 3-4 | — | — | 104.0 |

*¹Concentration of the anionic polymer, etc., relative to a mass of calcium carbonate
*²“EXCEL S-95” (tradename) available from Kao Corporation

From the results of Examples 1-1 to 1-6 and Examples 3-1 to 3-17, it is considered that in the case where the slurry viscosity of the mixture of the anionic polymer, the plasticizer and the basic inorganic filler is sufficiently low, the resulting halogen-based resin composition is improved in processability. Incidentally, in Examples 3-1 to 3-17 and Comparative Examples 3-1 to 3-4, the amount of calcium carbonate compounded relative to the plasticizer became large, so that there was such a tendency that the slurry viscosities of the resulting halogen-based resin compositions were increased as compared to those in Examples 1-1 to 1-6 and Comparative Examples 1-1 to 1-4.

In addition, the reason why the slurry viscosity of the mixture of the plasticizer and calcium carbonate in Comparative Example 3-4 was considerably large as compared to the slurry viscosity of the halogen-based resin composition obtained in Comparative Example 1-1 is considered to be that the content of calcium carbonate in the mixture of Comparative Example 3-4 was so large as to form a network structure of calcium carbonate, whereas the content of calcium carbonate in the halogen-based resin composition of Comparative Example 1-1 was relatively small, so that the calcium carbonate was inhibited from forming a network structure thereof to such an extent that the slurry viscosity of the resulting halogen-based resin composition was considerably increased.

### Measurement of Slurry Viscosity of Mixture Prepared Using Neutralized Anionic Polymer

### Examples 4-1 to 4-5

The same procedure as in Example 3-1 was repeated except that the kind of anionic polymer and the concentration of the anionic polymer relative to calcium carbonate were changed to those shown in Table 6, thereby preparing mixtures, and the slurry viscosities of the thus prepared respective mixtures were measured at 25° C. The results are shown in Table 6.

### Comparative Example 4-1

The anionic polymer 3 (a 20% neutralized product of the anionic polymer 1) in an amount of 0.4 g (corresponding to 0.5% in terms of a concentration of the anionic polymer relative to a mass of calcium carbonate), 40 g of a plasticizer (bis(2-ethylhexyl) phthalate) available from FUJIFILM Wako Pure Chemical Corporation and 85 g of calcium carbonate “WHITE H” (tradename) available from Shiraishi Calcium Kaisha Ltd., were sequentially charged into a 500 mL plastic cup in this order, and homogeneously mixed with each other using a spatula. Thereafter, the obtained mixture was mixed using a Labomixer at a rotating speed of 5,000 rpm for 3 minutes. Then, the mixture was allowed to stand at room temperature under reduced pressure for 10 minutes to subject the mixture to defoaming, thereby obtaining a mixture of the anionic polymer 3, the plasticizer and calcium carbonate. The slurry viscosity of the thus obtained mixture as measured at 25° C. was 52 Pass. The results are shown in Table 6.

### Comparative Example 4-2

The same procedure as in Comparative Example 4-1 was repeated except that the anionic polymer 3 was replaced with the anionic polymer 5 (a 100% neutralized product of the anionic polymer 1), thereby obtaining a mixture of the anionic polymer 5, the plasticizer and calcium carbonate. The slurry viscosity of the thus obtained mixture as measured at 25° C. was 119 Pas. The results are shown in Table 6.

TABLE 6

| | |
|---|---|
| | Evaluation |
| Anionic polymer, etc. | results |

| | | | Concentration | Slurry viscosity |
|---|---|---|---|---|
| | | Kind | (% by mass)*¹ | (Pa · s) |
| Examples | 4-1 | 2 | 0.5 | 3.9 |
| | 4-2 | 3 | 0.5 | 11.0 |
| | 4-3 | 4 | 0.5 | 28.0 |
| | 4-4 | 5 | 0.5 | 5.4 |
| | 4-5 | 13 | 0.5 | 4.5 |
| Comparative | 4-1 | 3 | 0.5 | 52.0 |
| Examples | 4-2 | 5 | 0.5 | 119.0 |

*¹Concentration of the anionic polymer, etc., relative to a mass of calcium carbonate

From the results of Examples 4-1 to 4-5, it was confirmed that even in the case where the neutralized anionic polymers were used, when the respective components were added in the sequential order, it was possible to reduce the slurry viscosities of the resulting mixtures each composed of the anionic polymer, the plasticizer and the basic inorganic filler.

In addition, from the results of Examples 4-1 to 4-5 and Comparative Examples 4-1 and 4-2, it was confirmed that in the case where the neutralized anionic polymers were used, the method for production of the halogen-based resin composition in which the respective components were added in the sequential order after the step 1 was capable of reducing a slurry viscosity of the resulting halogen-based resin composition to a larger extent than the method for production of the halogen-based resin composition in which the respective components were added collectively at one time.

### Measurement of Slurry Viscosity of Mixture

### Example 5-1

The same procedure as in Example 3-11 was repeated except that the plasticizer was replaced with a trimellitate (tris(2-ethylhexyl) trimellitate) available from Tokyo Chemical Industry Co., Ltd., thereby preparing a mixture, and the slurry viscosity of the thus prepared mixture was measured at 25° C. The results are shown in Table 7.

### Example 5-2

The same procedure as in Example 3-14 was repeated except that the plasticizer was replaced with the aforementioned trimellitate, thereby preparing a mixture, and the slurry viscosity of the thus prepared mixture was measured at 25° C. The results are shown in Table 7.

### Comparative Example 5-1

The same procedure as in Comparative Example 3-1 was repeated except that the plasticizer was replaced with the aforementioned trimellitate, thereby preparing a mixture, and the slurry viscosity of the thus prepared mixture was measured at 25° C. The results are shown in Table 7.

TABLE 7

| | |
|---|---|
| | Evaluation |
| Anionic polymer | results |

| | | | Concentration | Slurry viscosity |
|---|---|---|---|---|
| | | Kind | (% by mass)*¹ | (Pa · s) |
| Examples | 5-1 | 12 | 0.5 | 9.6 |
| | 5-2 | 15 | 0.5 | 17.9 |
| Comparative | 5-1 | — | — | 359.8 |
| Example | | | | |

*¹Concentration of the anionic polymer relative to a mass of calcium carbonate

From the results of Examples 5-1 and 5-2 and Comparative Example 5-1, it was confirmed that even in the case where the trimellitate was used as the plasticizer, it was possible to reduce the slurry viscosities of the obtained mixtures each composed of the polymer dispersant, the plasticizer and the basic inorganic filler, so that the resulting halogen-based resin compositions were improved in processability.

Incidentally, the reason why the slurry viscosities of the mixtures obtained in Examples 5-1 and 5-2 were higher than the slurry viscosities of the mixtures obtained in Examples 3-11 and 3-14 is considered to be that the viscosity of the trimellitate as the plasticizer is higher than the viscosity of bis(2-ethylhexyl) phthalate.

### INDUSTRIAL APPLICABILITY

In accordance with the present invention, it is possible to provide a method for producing a halogen-based resin composition that is improved in processability by reducing a slurry viscosity upon production of the halogen-based resin composition. The halogen-based resin composition produced by the production method of the present invention has excellent processability, and is therefore useful as housing interior products, packaging materials, agricultural materials, substrate protecting materials, cloth covering materials, sheathing materials for electric cables, various leather products, various foamed products, general-purpose hoses, gaskets, packing, boots, toys, food packaging materials, medical products, and the like.

1. A method for producing a halogen-based resin composition, comprising the following steps 1 to 3 in which the step 1 is first carried out:
Step 1: mixing an anionic polymer and a plasticizer with each other;
Step 2: further mixing a basic inorganic filler with a mixture obtained in the preceding step; and
Step 3: further mixing a halogen-based resin with a mixture obtained in the preceding step.

2. The method for producing a halogen-based resin composition according to claim 1, wherein the steps 1 to 3 are carried out in sequential order.

3. The method for producing a halogen-based resin composition according to claim 1 or 2, wherein the anionic polymer comprises a carboxy group.

4. The method for producing a halogen-based resin composition according to any one of claims 1 to 3, wherein a weight-average molecular weight of the anionic polymer is not less than 4,000 and not more than 200,000.

5. The method for producing a halogen-based resin composition according to any one of claims 1 to 4, wherein a mass ratio of the anionic polymer to the basic inorganic filler after being mixed is not less than 0.0001 and not more than 10.

6. The method for producing a halogen-based resin composition according to any one of claims 1 to 5, wherein the basic inorganic filler comprises calcium carbonate.

7. The method for producing a halogen-based resin composition according to any one of claims 1 to 6, wherein the halogen-based resin comprises at least one resin selected from the group consisting of a vinyl chloride resin, a vinylidene chloride resin and a chloroprene rubber.
